(19) United States
(12) Patent Application Publication
(10) Pub. No.: US 2013/0309452 A1
(43) Pub. Date: Nov. 21, 2013

(54) LAMINATE AND METHOD FOR PRODUCING LAMINATE

(71) Applicants: Kiyoshi Minoura, Osaka-shi (JP); Chiaki Minari, Osaka-shi (JP); Kenji Okamoto, Osaka-shi (JP); Nobuaki Yamada, Osaka-shi (JP)

(72) Inventors: Kiyoshi Minoura, Osaka-shi (JP); Chiaki Minari, Osaka-shi (JP); Kenji Okamoto, Osaka-shi (JP); Nobuaki Yamada, Osaka-shi (JP)

(73) Assignee: SHARP KABUSHIKI KAISHA, Osaka-shi, Osaka (JP)

(21) Appl. No.: 13/982,853

(22) PCT Filed: Jan. 24, 2012
(86) PCT No.: PCT/JP2012/051378

§ 371 Date: Jul. 31, 2013

(30) Foreign Application Priority Data
Feb. 1, 2011 (JP) 2011-020096

(51) Int. Cl. G02B 1/11

(52) U.S. Cl. CPC G02B 1/111
USPC 428/141; 427/510

(57) ABSTRACT

A laminate includes a base and a moth-eye film in a combined manner. The laminate can be easily bonded to a polarizer without performing a saponification treatment and can provide pencil hardness and scratch resistance without disposing a hard coat layer. The laminate of an embodiment of the present invention is directed to a laminate including an anti-reflection film including a plurality of protruding portions arranged so that a width between peaks of adjacent protruding portions is less than or equal to a wavelength of visible light and an acrylic base on which the anti-reflection film is placed. In the laminate, the anti-reflection film and the acrylic base are directly bonded to each other.

### TECHNICAL FIELD

The present invention relates to a laminate and a method for producing the laminate. More specifically, the present invention relates to a laminate including a moth-eye film that can reduce the surface reflection of a display apparatus by being laminated onto a member constituting the outermost surface of the display apparatus, such as a polarizing plate, and to a method for producing the laminate.

### BACKGROUND ART

Polarizing plates often used in liquid crystal display apparatuses include a polarizer that can convert natural light emitted from a light source into polarized light which oscillates in a particular direction. Polarizers are often composed of a polyvinyl alcohol (PVA)-based film to which an iodine complex or a dichromatic dye is adsorbed. Polarizers are produced by drawing such a film.

However, since such a PVA-based film is composed of a hydrophilic polymer, the deformation and shrinkage considerably occur particularly under humid conditions and thus the mechanical strength of the film itself is low. Therefore, a base that is composed of triacetyl cellulose (TAC) or the like and that functions as a base film for protecting the polarizer is generally laminated on both surfaces or one surface of the polarizer. Thus, the strength of the polarizing plate can be increased and the reliability of the polarizer can be achieved.

A certain treatment that increases the adhesiveness at an interface between the polarizer and the base film needs to be performed in order to laminate the polarizer onto the base film. Furthermore, the polarizer needs to be laminated onto the base film without impairing the characteristics of the polarizer. To achieve the above requirements, various studies have been conducted and the following proposals (1) to (8) have been made.

(1) There is proposed a method in which, when a polarizing film and a polyacrylic resin film serving as a surface protective layer of the polarizing film are bonded to each other, a liquid material mainly composed of a vinyl monomer and/or a vinyl oligomer that provides stickiness by melting or swelling the top-layer portion of the polyacrylic resin film is applied between the polarizing film and the polyacrylic resin film and polymerized by heating to bond the polarizing film and the resin film (e.g., refer to PTL 1).

(2) There is proposed a method in which, when a polarizing film obtained by adsorbing and orienting a dichromatic dye onto a polyvinyl alcohol-based film and a protective film formed of a cellulose-based film are laminated to each other using an adhesive, a corona treatment for increasing the surface tension is performed on a surface of the cellulose-based film on the polarizing plate side (e.g., refer to PTL 2).

(3) There is proposed a method in which, for the purpose of improving the adhesiveness with a polyvinyl alcohol film used as a polarizer, a surface of a protective film is hydrophilized by performing a plasma treatment (e.g., refer to PTL 3).

(4) There is proposed a method in which, for the purpose of improving the adhesiveness between a polarizer and a protective film containing a (meth)acrylic resin, an adhesive layer containing a polyvinyl alcohol resin having an acetoacetyl group and an adhesion-improving layer containing a cross-linking agent and a urethane resin having a carboxyl group are inserted between the polarizer and the protective film (e.g., refer to PTL 4).

(5) There is proposed a method in which, in a polarizing plate obtained by laminating a thermoplastic resin film mainly composed of a lactone ring-containing polymer and serving as a protective film on one surface of a polarizer, an adhesion-improving layer containing a polyurethane resin and/or an amino group-containing polymer is formed on a surface of the thermoplastic resin film, the surface facing the polarizer (e.g., refer to PTL 5).

(6) There is proposed a method in which an ultraviolet-curable adhesive is applied between a protective film composed of a thermoplastic resin and a polarizing film formed of a uniaxially drawn polyvinyl alcohol resin film onto which iodine or a dichromatic dye is adsorbed and oriented to form an adhesive layer, and they are heated before irradiation with ultraviolet rays (e.g., refer to PTL 6).

(7) There is proposed a method in which a protective film of a polarizing plate is composed of a norbornene resin instead of TAC, and an ultraviolet absorber is added to the norbornene resin, which does not have a property of absorbing ultraviolet rays, to impart ultraviolet absorbability (e.g., refer to PTL 7).

(8) There is proposed a method in which a laminate including a pair of acrylic resins having a glass transition temperature (Tg) higher than or equal to a particular glass transition temperature and an intermediate layer that is composed of an ultraviolet absorber and a thermoplastic resin and is formed between the pair of acrylic resins is used as a layer (viewer-side protective layer) for protecting a surface layer of a polarizer, and the viewer-side protective layer and the polarizer are bonded to each other with an active energy ray-curable resin not containing a solvent (e.g., refer to PTL 8).

As described above, various schemes are required to laminate a polarizer and a base film. However, since a polarizing plate is generally disposed at the forefront of a liquid crystal display apparatus, the base film also needs to have properties as a member constituting the outermost surface of the display apparatus. Specifically, the base film preferably has functions such as anti-reflectivity, an anti-glare property, a hard coat property, an antistatic property, an antifouling property, a gas barrier property, and an ultraviolet (UV) blocking property. Materials that can easily impart such properties are suitable as a material constituting the polarizing plate of a liquid crystal display apparatus.

The following method is known as a method for imparting anti-reflectivity to a surface of general display apparatuses including liquid crystal display apparatuses. That is, a high-refractive-index hard coat layer and a low-refractive-index layer are laminated on a transparent plastic film serving as a base in that order to reduce the reflection at the surface of the transparent plastic film (e.g., refer to PTL 9).

Regarding a technique for reducing the surface reflection of display apparatuses, a moth-eye structure that can produce higher anti-reflection effects than light interference films (e.g., low-reflection (LR) films and anti-reflection (AR) films) has been receiving attention. In a moth-eye structure, depressions and projections having intervals shorter than or equal to the wavelength of visible light, the depressions and projections being finer than those formed in an anti-glare (AG) film, are arranged without leaving any space on a surface of an article to be subjected to an anti-reflection treatment, whereby the change in refractive index at the interface between the outside (air) and the surface of the article is made to be pseudo-continuous. Such a moth-eye structure transmits substantially all the light regardless of the refractive index of the interface, and thus light reflection at the surface of the article can be substantially eliminated (e.g., refer to PTLs 10 and 11).

Such a moth-eye structure can be formed, for example, by coating a base with a photo-curable resin and then transferring a fine irregular structure onto a surface of the coated film while at the same time curing the resin by irradiation with light. When the base is made of a plastic such as polymethyl methacrylate (PMMA) or polycarbonate, it has been reported to be generally effective from the viewpoint of achieving good adhesiveness that heating is performed after the coating of the photo-curable resin (e.g., refer to NPL 1).

Focusing on properties other than anti-reflectivity, for example, focusing on a point that a phase difference film needs to be disposed in addition to the polarizer to more precisely control the transmission and blocking of light in a polarizing plate, studies on imparting a phase difference compensation function to a base film, that is, using a base film having a phase difference compensation function have been conducted (e.g., refer to NPL 2).

As described above, there are many examples regarding the selection of a material for the base film that protects the polarizer and the laminate structure. However, the selection of a material in consideration of the case where additional properties such as anti-reflectivity (in particular, moth-eye film) are imparted and an appropriate laminate structure have not been sufficiently studied yet, and there is still room for improvement.

### CITATION LIST

### Patent Literature

PTL 1: Japanese Unexamined Patent Application Publication No. 62-23285
PTL 2: Japanese Unexamined Patent Application Publication No. 64-32203
PTL 3: Japanese Unexamined Patent Application Publication No. 2000-356714
PTL 4: Japanese Unexamined Patent Application Publication No. 2009-193061
PTL 5: Japanese Unexamined Patent Application Publication No. 2007-127893
PTL 6: Japanese Unexamined Patent Application Publication No. 2010-230806
PTL 7: Japanese Unexamined Patent Application Publication No. 2002-249600
PTL 8: Japanese Unexamined Patent Application Publication No. 2008-40277
PTL 9: Japanese Unexamined Patent Application Publication No. 7-287102
PTL 10: International Publication No. 2007/040159
PTL 11: Japanese Unexamined Patent Application Publication No. 2009-31764

### Non Patent Literature

NPL 1: “Toagosei Group Annual Research Report TREND 2006”, Japan, No. 9, pp. 19-24
NPL 2: “Current situation and future outlook for LCD-related markets 2010”, Japan, Vol. 2, pp. 197-198

### SUMMARY OF INVENTION

### Technical Problem

The inventors of the present invention have conducted various studies on the adhesiveness, reliability, and the like in the case where a base film for protecting a polarizer is used as a base of an anti-reflection film (hereinafter also referred to as a moth-eye film) having a plurality of protruding portions formed on the surface thereof at nano-order intervals and the base film of a polarizing plate is composed of TAC.

When a PVA film is laminated onto a TAC film, the hydrophilicity on the surface of the TAC film needs to be increased and saponification is effective for such a treatment. A saponification treatment is an excellent technique in terms of the effect of imparting hydrophilicity and the efficiency of conducting processes because a hydrophilic group can be provided to the surface of the TAC film within a short time.

FIG. 48 is a schematic view showing the state in which a saponification treatment is being performed. FIG. 49 is a schematic view showing the state after the saponification treatment. Herein, it is shown that a TAC film 114 having a surface on which a moth-eye film 111 is formed is saponified. In the saponification treatment, the whole object needs to be immersed in a saponification liquid 118 as shown in FIG. 48. A hard coat resin layer 117 for easily forming the moth-eye film 111 on the TAC film 114 is disposed between the TAC film 114 and the moth-eye film 111. The saponification liquid 118 is a 2 N aqueous sodium hydroxide (NaOH) solution at 50° C.

However, as a result of the studies conducted by the inventors of the present invention, the following has been found. When the moth-eye film 111 is formed on the TAC film 114, a TAC film eluted material 114a and a moth-eye film transferring resin eluted material 111a that are eluted through immersion in the saponification liquid 118 adhere to the surface of the moth-eye film 111. When washing with water and drying are performed after the saponification treatment, these eluted materials 111a and 114a are precipitated on the surface of the moth-eye film 111 in the form of needle-shaped foreign matter.

More specifically, the TAC film eluted material 114a and the transferring resin eluted material 111a appear as a result of the elution caused by an alkali in the saponification treatment. When washing with water is performed after the saponification treatment, the alkali concentration decreases and the eluted material 114a derived from the TAC film 114 is precipitated by crystallization using the eluted material 111a derived from the moth-eye film 111 as a nucleus. Foreign matter that adheres to the surface of a nano-order protruding structure such as a moth-eye structure cannot be easily washed away with water or the like. Consequently, as shown in FIG. 49, a crystallized material 119 is left on the surface of the moth-eye film 111 after drying. Since the moth-eye film 111 transmits light and prevents reflection by eliminating the change in refractive index at the air interface in a pseudo manner, such foreign matter degrades the anti-reflectivity of the moth-eye film 111.

As a result of further studies, the inventors of the present invention have found the following. In the case where a polarizing plate is produced using a TAC film including a moth-eye film as a base, if the TAC film is coiled while the foreign matter adheres to the surface of the TAC film, the TAC film is scratched and defects may be formed in the polarizing plate. FIG. 50 is a schematic view showing the state in which the TAC film is being coiled.

TAC is a considerably soft material having a hardness of 2B to B in the pencil hardness test based on JIS K 5600-5-4. When a TAC film 121 is coiled as shown in FIG. 50, the coiling is generally performed while the surface of the TAC film 121 is cleaned using an adhesive roller. However, when the moth-eye film is formed on the surface of the TAC film 121, use of highly sticky glue easily causes adhesive residue on the nano structure and thus a highly sticky adhesive roller cannot be used. Therefore, there is no measure taken to remove the foreign matter that adheres to the surface of the moth-eye film. If the TAC film 121 is coiled while the foreign matter is caught in the TAC film 121, a defect is caused in a portion to which the foreign matter adheres and, after one revolution, the same defect is caused again. Such a defect is caused every time coiling occurs in a portion that overlaps the portion where the foreign matter has been caught, which causes a serious defect on the whole.

In addition to the studies described above, the inventors of the present invention have also focused on the pencil hardness and scratch resistance of the surface of the moth-eye film. FIG. 51 is a schematic view in which the moth-eye film is classified on the basis of the relationship between the hardness of a resin of the moth-eye film and the pencil hardness and scratch resistance. A moth-eye film 131 has a structure in which nano-order protrusions are arranged. When a mechanical stimulus such as tracing with a pencil or rubbing with steel wool is provided, the stress is concentrated on individual protrusions. Herein, if the transferring resin itself of the moth-eye film 131 is hardened, the resistance to pressure applied in a direction in which a pencil 135 is pressed, that is, the pencil hardness is improved. However, when rubbing with steel wool is performed, the protrusions become brittle, for example, the edges of the protrusions are broken, resulting in insufficient steel wool resistance. On the other hand, when the transferring resin of the moth-eye film 131 is softened so that, even if rubbing is provided, the protrusions flexibly return to their original state, the surface becomes slippery and thus the steel wool resistance is improved. However, when the pressure is applied in a direction in which the pencil 135 is pressed, the protrusions become deformed and do not return to their original state. Consequently, the protrusions are fixed while being deformed.

To overcome the above problem, there is a method in which a hard coat layer is disposed between a base 132 and the moth-eye film 131. By disposing the hard coat layer serving as a lower layer and the moth-eye film transferring resin serving as an upper layer on the base and adjusting the balance of the hardnesses of these layers, the hardness can be achieved by the hard coat layer and the flexibility can be achieved by the moth-eye film transferring resin. As a result, both high pencil hardness and high scratch resistance can be achieved.

The method in which the hard coat layer is disposed is also effective in terms of the adhesiveness between the TAC film and the moth-eye film. For example, when the moth-eye film is formed on the TAC film by a roll-to-roll process, the adhesiveness of the transferring resin serving as a base for the moth-eye film to the TAC film is low. In particular, the transferring resin is easily detached when evaluation is carried out using a cross-cut test based on JIS K 5600-5-6. FIG. 52 is a schematic view showing the state in which the cross-cut test is being carried out. The cross-cut test is a test in which a film 141 to be evaluated is attached to a base 142, cuts are made using a cutter so that 10×10 squares are formed, and the film 141 is forcefully peeled off, and then the adhesiveness is evaluated on the basis of the number of squares left.

The cause of the above problem is as follows. The base and the moth-eye structure transferring resin are in different initial states even if they are composed of the same type of material such as acrylic resin. Therefore, there is an interface formed between the base and the transferring resin. When the contact area between the base and the transferring resin is large, the adhesiveness is achieved to some extent. However, when the contact area is small, the adhesiveness is degraded.

This problem can also be overcome by using a hard coat layer. The following method can be considered. A hard coat layer serving as a lower layer and a moth-eye film transferring resin serving as an upper layer are disposed on a base. When the hard coat layer is formed on the base, the base is melted using a solvent to produce a region in which a component eluted from the base and the solvent are mixed with each other. Consequently, the contact area between the base and the hard coat interface is increased. Furthermore, when the transferring resin is applied onto the hard coat layer, the hard coat layer is not completely cured to produce a region in which a hard coat layer component and a transferring resin component are partly mixed with each other. Consequently, the contact area between the hard coat layer and the transferring resin interface is increased.

However, as a result of thorough studies, the inventors of the present invention have found that, when such a hard coat layer is used, the following problem arises.

FIG. 53 is a schematic view showing the state in which a moth-eye structure is being provided to a moth-eye film transferring resin by rotating a die whose surface has nano-order protrusions on a surface of a film formed by laminating a base, a hard coat layer, and the moth-eye film transferring resin.

In FIG. 53, a long arrow located on the right side indicates a transferring direction. A region above the die is an untransferred region and a region below the die is a transferred region. A die 154 has a cylindrical structure and can rotate. An example of the size of each film is shown below. In the case where the transfer is performed onto a base 152 having a width of 1340 mm, which is a current standard, the width of a hard coat layer 153 is 1300 mm because a coating margin of 20 mm on one side needs to be taken with respect to an inner film. Furthermore, in consideration of the coating margin of 20 mm on one side required with respect to an inner film, the width of a transferring resin 151 needs to be 1260 mm. In other words, as the number of films laminated increases, the width of a moth-eye film that can be formed at one time decreases.

When the moth-eye film is formed by the method shown in FIG. 53, the clogging of the die 154 may be caused. In the above-described method, the die 154 does not move by being clogged in a portion where the outermost surface of the hard coat layer 153 appears because the hard coat layer 153 is composed of a hard resin and has poor releasability. In addition, the film is sometimes torn due to the disturbance of the stress balance with other members.

When considering the chronological order in which the die 154 comes into contact with the films in a transferring step, the die 154 contacts the base 152 first, then the hard coat layer 153, and subsequently the transferring resin 151. When the die 154 contacts the transferring resin 151, the die 154 also contacts regions of the hard coat layer 153 and base 152, the regions each serving as a margin. At the end of the transferring step, the die 154 contacts the transferring resin 151, then the hard coat layer 153, and finally the base 152. Therefore, the die 154 contacts the hard coat layer 153 in both side regions disposed as coating margins, a transfer start region, and a transfer end region. In both side regions of the hard coat layer 153, the problem can be overcome by removing the depressions and projections of the die 154, but an additional step is required. In addition, it is impossible to avoid the contact in the transfer start region and transfer end region. As described above, it is difficult to avoid the contact between the hard coat layer 153 and the die 154 in the production process.

The presence of the hard coat layer causes problems of steel wool resistance (scratch resistance) and curling. If the hard coat layer is completely cured, the transferring resin layer does not adhere to the hard coat layer. Therefore, a solvent needs to be volatilized after the application of the hard coat layer, but the transferring resin layer needs to be applied while the polymerization is not completed. If the transferring resin layer is not completely cured, low-molecular-weight components are mutually diffused. If a hard and brittle component of the hard coat layer diffuses into the transferring resin layer, the steel wool resistance is degraded. Therefore, the hard coat layer needs to be formed with such a thickness that the low-molecular-weight components do not diffuse. However, if the total thickness of the hard coat layer and the transferring resin layer is excessively larger than the thickness of the base film, another problem in which the entire laminate is curled is caused.

In view of the foregoing, it is an object of the present invention to provide a laminate including a base and a moth-eye film in a combined manner. The laminate can be easily bonded to a polarizer without performing a saponification treatment and can provide the pencil hardness and scratch resistance without disposing a hard coat layer.

### Solution to Problem

As a result of detailed studies on the above problems, the inventors of the present invention have reached a conclusion that an acrylic resin is used for the base on which the moth-eye film is formed. Since an acrylic resin is harder than TAC, a defect is not caused even if foreign matter is caught during coiling. A UV absorber can be easily added to an acrylic resin and thus the UV degradation of a polarizer is effectively suppressed. Furthermore, when a hard acrylic base is used, a soft transferring resin can be formed. The hardness can be achieved by the base and the flexibility can be achieved by adjusting the softness of the transferring resin. As a result, both high pencil hardness and high scratch resistance can be achieved at the same time.

In other words, the formation of the hard coat layer is not required by employing an acrylic resin as a material of the base. The problems of steel wool resistance (scratch resistance) and curling and the problem of clogging of a die can be overcome by not forming the hard coat layer. Furthermore, since the hard coat layer is not formed, a region in which the moth-eye film is transferred is expanded, which increases the production efficiency. It is also considered that a transferring resin is applied without completely curing the hard coat layer in order to achieve sufficient adhesiveness. However, the die is easily clogged with the hard coat layer compared with the transferring resin that achieves flexibility because the hard coat layer is composed of a resin that achieves hardness.

In terms of the adhesiveness of acrylic resin and PVA, hydrophilicity can be provided to the surface of an acrylic base by using a mixed solution of a solid component and a solvent for achieving the adhesion without performing saponification.

It has also been studied that a cycloolefin polymer (COP) is used for the base, but the use of a cycloolefin polymer has been given up for the following reason. Typical examples of a base composed of COP include ZEONOR (manufactured by ZEON CORPORATION) and ARTON (Okura Industrial Co., Ltd.). In the case where the base is applied to a polarizing plate, a step of drying a PVA film is required and thus a base having high moisture permeability is advantageously used. In this regard, COP is superior to acrylic resin and TAC. According to the studies conducted by the inventors of the present invention using the measurement method of the moisture permeability based on JIS K 7129, the moisture permeability of COP is 1.0 (g/m²/24 hr), the moisture permeability of acrylic resin is 50 (g/m²/24 hr), and the moisture permeability of TAC is 200 (g/m²/24 hr). Similarly to acrylic resin, the saponification treatment is not required for COP because a solvent can be used, but COP is softer than TAC. Therefore, a hard coat layer needs to be formed on both sides of a COP film to provide pencil hardness. In the case where the base is applied to a polarizing plate, the base needs to have UV absorbability. It is easy to add a UV absorber to acrylic resin whereas it is difficult to add a UV absorber to COP. When COP is used, a UV absorbing layer needs to be additionally formed.

The inventors of the present invention have successfully overcome the above problems as described above and have completed the present invention.

According to an aspect of the present invention, there is provided a laminate including an anti-reflection film including a plurality of protruding portions arranged so that a width between peaks of adjacent protruding portions is less than or equal to a wavelength of visible light and an acrylic base on which the anti-reflection film is placed, wherein the anti-reflection film and the acrylic base are directly bonded to each other.

The laminate of the present invention is not particularly limited by other constituent elements as long as the laminate is formed using the above constituent elements as essential elements.

The laminate of the present invention includes an anti-reflection film and an acrylic base on which the anti-reflection film is placed. The anti-reflection film can reduce the reflection at the surface of the base by being laminated onto the base. For example, by applying the laminate of the present invention as a member constituting a foremost surface of a display apparatus, a display apparatus that displays a good image with fewer reflections of surroundings (e.g., fluorescent lamps in a room) caused by the reflection of outside light can be provided.

Since an acrylic resin is harder than TAC and COP, the balance of the pencil hardness and scratch resistance can be adjusted by using the acrylic resin and a moth-eye film transferring resin without additionally disposing a hard coat layer. An acrylic resin is also a material having good light transparency.

The anti-reflection film includes a plurality of protruding portions arranged so that a width between peaks of adjacent protruding portions is less than or equal to a wavelength of visible light. In this specification, the phrase “less than or equal to a wavelength of visible light” means 380 nm or less, which is the lower limit of a general wavelength range of visible light, preferably 300 nm or less, and more preferably 200 nm or less, which is about half the wavelength of visible light. If the width between peaks of protruding portions is more than 400 nm, coloring may be caused with a blue light wavelength component. However, the influence is sufficiently suppressed by adjusting the width to be 300 nm or less, and substantially no influence is exerted by adjusting the width to be 200 nm or less.

The anti-reflection film and the acrylic base are directly bonded to each other. According to the present invention, a hard coat layer generally disposed to improve the adhesiveness between the anti-reflection film and the base film is not required. This overcomes the problems of steel wool resistance (scratch resistance) and curling and the concerns such as the clogging of a die and the tearing of a film during the production.

Preferred embodiments of the laminate of the present invention will be described.

A polarizer is preferably disposed on a surface of the acrylic base, the surface being opposite a surface on which the anti-reflection film is placed. By bonding a polarizer, a polarizing plate having considerably low reflectivity at its surface can be produced. Furthermore, since the anti-reflection film has both hardness and flexibility due to the features of the present invention, a polarizing plate that has resistance to external pressure and scratches and can be suitably applied to the outermost surface of a display apparatus can be obtained.

An aqueous adhesive layer is preferably formed between the acrylic base and the polarizer, and a hydrophilic film is preferably formed between the acrylic base and the aqueous adhesive layer. A film material commonly used for polarizing plates has an improvement in terms of adhesiveness with an acrylic base. By using the combination of the aqueous adhesive layer and hydrophilic film, sufficient adhesiveness can be achieved without contaminating the polarizer.

The inventors of the present invention have found that such a laminate can be produced by the following method.

According to another aspect of the present invention, there is provided a method (hereinafter also referred to as a first production method of the present invention) for producing a laminate including an anti-reflection film including a plurality of protruding portions arranged so that a width between peaks of adjacent protruding portions is less than or equal to a wavelength of visible light and an acrylic base on which the anti-reflection film is placed, the method including a coating step of coating an acrylic base with a resin composition; after the coating step, a heating step of heating the resin composition at 60° C. or higher for 30 seconds or longer while pressing a die against the resin composition; and after the heating step, a transferring step of curing the resin composition by irradiating the resin composition with light while keeping the die pressed against the resin composition.

The resin composition used in the first production method of the present invention is composed of a photo-curable resin that is cured by irradiation with a certain amount of light. Any die can be used as the die as long as depressions and projections can be transferred onto the resin composition, and the die is not necessarily composed of a metal material. By using, as the above die, a die including a plurality of depressed portions arranged so that the width between bottom points of adjacent depressed portions is less than or equal to a wavelength of visible light, a plurality of the above-described protruding portions can be disposed on the resin composition.

In the first production method of the present invention, before the depressions and projections are transferred and the resin composition is cured, the resin composition is heated at 60° C. or higher for 30 seconds or longer. This improves the adhesiveness between the acrylic base and the resin composition. If the heating conditions are lower than 60° C. and shorter than 30 seconds, sufficient adhesiveness is sometimes not achieved. The heating step is preferably a step of heating the resin composition at 100° C. or lower for 3 minutes or shorter. If the heating is performed at higher than 100° C. for longer than 3 minutes, the base is excessively melted and may become cloudy.

In the first production method of the present invention, the resin composition is preferably composed of an undiluted solution for the anti-reflection film. According to the above heating step, a sufficient adhesive effect can be produced without using a solvent in the resin composition applied to the acrylic base, which simplifies the production of a moth-eye film.

According to another aspect of the present invention, there is provided a method (hereinafter also referred to as a second production method of the present invention) for producing a laminate including an anti-reflection film including a plurality of protruding portions arranged so that a width between peaks of adjacent protruding portions is less than or equal to a wavelength of visible light and an acrylic base on which the anti-reflection film is placed, the method including a coating step of coating an acrylic base with a resin material; and after the coating step, a transferring step of curing a resin composition while pressing a die against the resin composition, wherein the resin composition is composed of an constituent component of the anti-reflection film and a solvent.

The resin composition used in the second production method of the present invention is not particularly limited as long as an anti-reflection film including a plurality of protruding portions arranged so that a width between peaks of adjacent protruding portions is less than or equal to a wavelength of visible light can be produced with a die. Examples of the resin composition include photo-curable resin compositions, active energy ray-curable resin compositions such as electron beam-curable resin compositions, and thermosetting resin compositions. The same die as that used in the first production method of the present invention can be used.

In the second production method of the present invention, the resin composition contains a constituent component of the anti-reflection film and a solvent. The constituent component of the anti-reflection film used in this production method may be solid or liquid at room temperature. The solvent is preferably an organic solvent. A mixed solution prepared by dissolving a solid component in an organic solvent at least melts the surface of an acrylic base by immersing the acrylic base in the mixed solution for a long time, though the degree of the melting varies depending on the types of mixed solutions. Thus, the adhesiveness can be improved.

The solvent suitably used in this production method is selected from the group (hereinafter also referred to as a first group) consisting of ketones (e.g., acetone, methyl ethyl ketone (MEK), and methyl isobutyl ketone (MIBK)), aromatics (e.g., benzene, toluene, xylene, and phenol), chlorides (e.g., chloroform, ethylene dichloride, ethylene trichloride, and methylene dichloride), and acetates (e.g., ethyl acetate and glacial acetic acid). These solvents have high solvency and are particularly suitably used when the priority is given to adhesiveness.

Another solvent suitably used in this production method is selected from the group (hereinafter also referred to as a second group) consisting of methyl alcohol, ethyl alcohol, butyl alcohol, cyclohexane, cyclohexanone, and butyl acetate. These solvents have somewhat low solvency, but do not readily cause cloudiness of a base. Therefore, they are particularly suitably used when the priority is given to transparency. Note that these solvents may be used in combination.

When the solvent in the first group is used, after the dropping and before the drying, about 10 seconds are required to melt the surface of a base to an extent that the adhesiveness is improved. When the solvent in the second group is used, after the dropping and before the drying, about 2 minutes are required to melt the surface of a base to an extent that the adhesiveness is improved.

In the second production method of the present invention, the heating step in the first production method of the present invention is not necessarily performed. However, by performing the above heating step in combination, the adhesiveness can be further improved. In the second production method of the present invention, after the depressions and projections are transferred and before the resin composition is cured, the resin composition is preferably heated at 60° C. or higher for 30 seconds or longer. The heating step is more preferably a step of heating the resin composition at 100° C. or lower for 3 minutes or shorter. In this case, the resin composition is preferably an active energy ray-curable resin composition.

The first and second production methods of the present invention preferably further include a bonding step of bonding a polarizer onto a surface of the acrylic base, the surface being opposite a surface on which the anti-reflection film is placed. This can provide a polarizing plate having resistance to external pressure and scratches. Thus, the polarizing plate can be applied to the outermost surface of a display apparatus.

The bonding step preferably includes a hydrophilizing step of forming a hydrophilic film on the acrylic base. Examples of a hydrophilizing method include coating with Bell Clean, coating with a titanium oxide coating agent, coating with an antistatic antifouling coating agent, a corona treatment, a plasma treatment, and ultraviolet irradiation treatment. In particular, coating with Bell Clean (manufactured by NOF CORPORATION) is preferably employed. This can easily achieve a contact angle of 40° or less and also provide an antifouling property. A hybrid paint is exemplified as a component similar to Bell Clean and can provide hydrophilicity and an antifouling property. An example of the hybrid paint is a paint prepared by mixing, as hydrophilic solid components, silica nano particles and a resin (binder) that binds the silica nano particles and dissolving the solid components in a solvent. Such a hybrid paint can slightly melt only a top layer of a base, and thus high adhesiveness can be achieved without causing cloudiness.

After the hydrophilizing step, a contact angle at a surface of the acrylic base is preferably 30° or less at 25° C. The above production method preferably further include, after the hydrophilizing step, a drying step of volatilizing moisture in the hydrophilic film. Thus, even when an aqueous adhesive is used, the polarizer can be substantially completely prevented from being contaminated and high adhesiveness to the acrylic base can be achieved.

### Advantageous Effects of Invention

According to the laminate of the present invention, the acrylic base can exhibit hardness without disposing a hard coat layer and the moth-eye film can exhibit flexibility. Therefore, an article having excellent pencil hardness and scratch resistance in addition to excellent anti-reflectivity can be provided.

### BRIEF DESCRIPTION OF DRAWINGS

FIG. 1 is a schematic sectional view showing a liquid crystal display apparatus according to a first embodiment.

FIG. 2 is a schematic view showing the state in which a moth-eye structure is being provided to a moth-eye film transferring resin by rotating a die whose surface has nano-order protrusions on a surface of a film formed by laminating a base and the moth-eye film transferring resin.

FIG. 3 is a schematic view showing a roll-to-roll process in which a polarizing plate is produced by laminating a TAC base, a polarizing film, and an acrylic base including a moth-eye film on its surface.

FIG. 4 is a schematic perspective view of the moth-eye film of the first embodiment and shows the case where the unit structure of protruding portions has a cone shape.

FIG. 5 is a schematic perspective view of the moth-eye film of the first embodiment and shows the case where the unit structure of protruding portions has a quadrangular pyramid shape.

FIG. 6 is a schematic perspective view of the moth-eye film of the first embodiment and shows a shape in which the inclination decreases in the direction from a bottom point to a peak.

FIG. 7 is a schematic perspective view of the moth-eye film of the first embodiment and shows a shape in which the inclination decreases in the direction from a bottom point to a peak.

FIG. 8 is a schematic perspective view of the moth-eye film of the first embodiment and shows a shape in which the inclination increases in a region between a bottom point and a peak.

FIG. 9 is a schematic perspective view of the moth-eye film of the first embodiment and shows a shape in which the inclination increases in the direction from a bottom point to a peak.

FIG. 10 is a schematic perspective view of the moth-eye film of the first embodiment and shows the form in which points (contact points) on a surface at which the protruding portions are in contact with each other are at different levels.

FIG. 11 is a schematic perspective view of the moth-eye film of the first embodiment and shows the form in which points (contact points) on a surface at which the protruding portions are in contact with each other are at different levels.

FIG. 12 is a schematic perspective view of the moth-eye film of the first embodiment and shows the form in which points (contact points) on a surface at which the protruding portions are in contact with each other are at different levels.

FIG. 13 is a schematic perspective view showing the protruding portions of the moth-eye film in detail, which is an enlarged view showing the case where hanging bell-type protruding portions have saddles and saddle points.

FIG. 14 is a schematic perspective view showing the protruding portions of the moth-eye film in detail, which is an enlarged view showing the case where needle-type protruding portions have saddles and saddle points.

FIG. 15 is a schematic plan view in which projections and depressions of a moth-eye structure are further enlarged.

FIG. 16 is a schematic view showing a section taken along line A-A′ in FIG. 15 and a section taken along line B-B′ in FIG. 15.

FIG. 17 is a schematic view showing the principle through which the moth-eye film of the first embodiment achieves low reflection, which shows a sectional structure of the moth-eye film.

FIG. 18 shows the change in refractive index (effective refractive index) light incident upon the moth-eye film undergoes.

FIG. 19 is a schematic view showing a step in a production process of a polarizing plate in Example 1.

FIG. 20 is a schematic view showing a step in a production process of a polarizing plate in Example 1.

FIG. 21 is a schematic view showing a step in a production process of a polarizing plate in Example 1.

FIG. 22 is a schematic view showing a step in a production process of a polarizing plate in Example 1.

FIG. 23 is a schematic view showing a step in a production process of a polarizing plate in Example 1.

FIG. 24 is a schematic view showing a step in a production process of a polarizing plate in Example 1.

FIG. 25 is a graph showing the absorption characteristics of a visible light polymerization initiator A.

FIG. 26 is a graph showing the absorption characteristics of a visible light polymerization initiator B.

FIG. 27 is a photograph showing the result provided by checking the height of protruding portions of the moth-eye film.

FIG. 28 is a photograph showing the result provided by checking the thickness of the moth-eye film.

FIG. 29 is a photograph that was taken from diagonally above and shows the surface structure of the moth-eye film.

FIG. 30 shows the measurement results of the reflectance of produced samples.

FIG. 31 is a schematic view showing a step in a production process of a polarizing plate in Example 2.

FIG. 32 is a schematic view showing a step in a production process of a polarizing plate in Example 2.

FIG. 33 is a schematic view showing a step in a production process of a polarizing plate in Example 2.

FIG. 34 is a schematic view showing a step in a production process of a polarizing plate in Example 2.

FIG. 35 is a schematic view showing a step in a production process of a polarizing plate in Example 2.

FIG. 36 is a photograph showing the results of an evaluation test for adhesiveness of samples A to D that use a hydrophilic acrylic resin.

FIG. 37 is a photograph showing the results of an evaluation test for adhesiveness of samples E to H that use a hydrophobic acrylic resin.

FIG. 38 is an enlarged photograph of the surface of the sample A.

FIG. 39 is an enlarged photograph of the surface of the sample B.

FIG. 40 is an enlarged photograph of the surface of the sample C.

FIG. 41 is an enlarged photograph of the surface of the sample D.

FIG. 42 is a photograph showing a section near the surface of a die used to produce a sample of Comparative Example 1.

FIG. 43 is a photograph showing an upper surface of the die used to produce the sample of Comparative Example 1.

FIG. 44 is a low magnification photograph showing the state of abnormally grown particles immediately after the formation of an aluminum film.

FIG. 45 is a high magnification photograph showing the state of abnormally grown particles immediately after the formation of an aluminum film.

FIG. 46 is a photograph showing the surface of a die after anodization and etching were repeatedly performed.

FIG. 47 is a schematic sectional view showing a test for examining the adhesiveness between a moth-eye film and an acrylic base.

FIG. 48 is a schematic view showing the state in which a saponification treatment is being performed.

FIG. 49 is a schematic view showing the state after the saponification treatment.

FIG. 50 is a schematic view showing the state in which a TAC film is being coiled.

FIG. 51 is a schematic view in which the moth-eye film is classified on the basis of the relationship between the hardness of a resin of the moth-eye film and the pencil hardness and scratch resistance.

FIG. 52 is a schematic view showing the state in which a cross-cut test is being carried out.

FIG. 53 is a schematic view showing the state in which a moth-eye structure is being provided to a moth-eye film transferring resin by rotating a die whose surface has nano-order protrusions on a surface of a film formed by laminating a base, a hard coat layer, and the moth-eye film transferring resin.

### DESCRIPTION OF EMBODIMENTS

An embodiment of the present invention will now be further described in detail with reference to the attached drawings, but the present invention is not limited to only the embodiment.

A laminate of the present invention and a laminate produced by a production method of the present invention can be applied to, for example, constituent members (e.g., self-emitting display elements, non-self-emitting display elements, light sources, light diffusion sheets, prism sheets, polarized-light-reflecting sheets, phase difference plates, polarizing plates, front plates, and casings) of display apparatuses, lenses, window panes, glasses of frames, shop windows, water tanks, printed articles, photos, coated articles, and illuminating apparatuses.

### First Embodiment

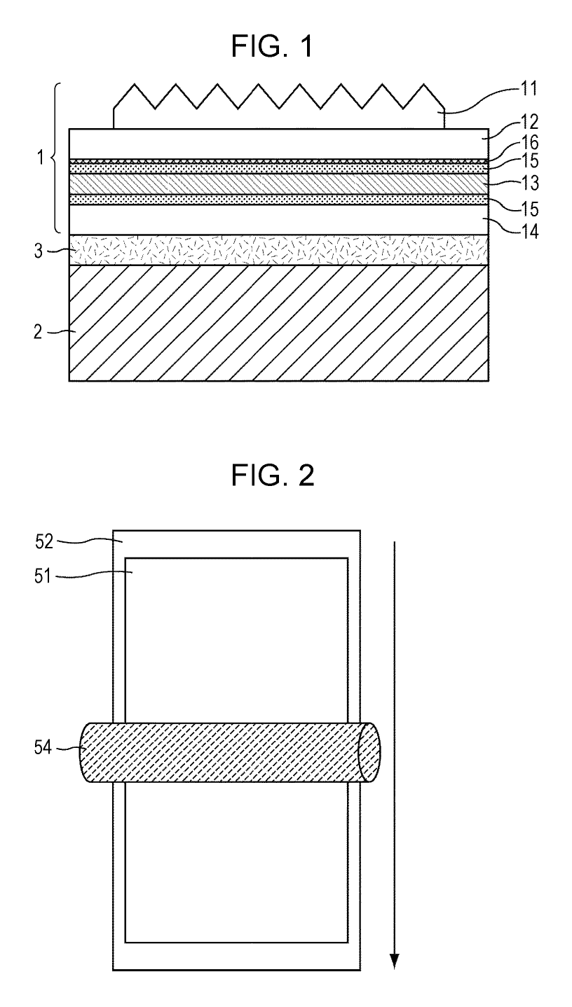

In a first embodiment, the case where the laminate of the present invention is used as a polarizing plate, which is one of members in a liquid crystal display apparatus, will be described. FIG. 1 is a schematic sectional view showing a liquid crystal display apparatus according to the first embodiment. As shown in FIG. 1, the liquid crystal display apparatus according to the first embodiment includes a liquid crystal display panel 2 and a polarizing plate 1 laminated in that order toward the outer side (top side). The liquid crystal display panel 2 and the polarizing plate 1 are bonded to each other through an adhesive 3. Note that another polarizing plate (not shown) is bonded to the rear side (back side) of the liquid crystal display panel 2. The polarizing plate 1 includes a triacetyl cellulose (TAC) base (first base) 14, an adhesive 15, a polarizing film 13, an adhesive 15, a hydrophilic film 16, an acrylic base (second base) 12, and a moth-eye film (anti-reflection film) 11 laminated in that order toward the display side, which can reduce the reflection at the surface of the polarizing plate 1. The adhesive 15 is disposed between the polarizing film 13 and the TAC base 14 and between the polarizing film 13 and the acrylic base 12 to laminate the members. No member is disposed between the acrylic base 12 and the moth-eye film 11. A hydrophilic treatment for improving the adhesiveness is performed between the polarizing film 13 and the acrylic base 12, that is, the hydrophilic film 16 is formed therebetween.

The liquid crystal display panel 2 includes a pair of glass substrates and a liquid crystal layer sealed between the pair of glass substrates. By controlling the voltage application to the liquid crystal layer, the orientation of liquid crystal molecules contained in the liquid crystal layer is controlled and the degree of birefringence imparted to light that is transmitted through the liquid crystal layer can be adjusted. Therefore, by further combining a polarizing plate, the transmission and blocking of light (On and Off of display) can be controlled.

In the first embodiment, the moth-eye film 11 is formed on the outer side of the acrylic base 12. Most of light incident upon the surface of the moth-eye film 11 is transmitted through the interface between the air and the moth-eye film 11 and the interface between the moth-eye film 11 and the acrylic base 12. Therefore, an anti-reflection effect much better than that of known light-interference-type anti-reflection films can be produced. As a result, a liquid crystal display apparatus with good display quality can be provided.

FIG. 2 is a schematic view showing the state in which a moth-eye structure is being provided to a moth-eye film transferring resin by rotating a die whose surface has nano-order protrusions on a surface of a film formed by laminating a base and the moth-eye film transferring resin. A hard coat layer is not formed below a transferring resin 51, and the transferring resin 51 and an acrylic base 52 are in direct contact with each other. A die 54 has a cylindrical structure and can rotate. The structure of the die 54 is not limited to the cylindrical structure, and may be a plate-shaped structure. The die 54 has nano-order depressions and projections on its surface. The nano-order depressions and projections are transferred onto the surface of the moth-eye film transferring resin 51 by pressing the die 54 against the transferring resin 51. At the same time, a transferring resin-curing step that uses light irradiation or the like is performed and thus a moth-eye structure can be formed.

In the first embodiment, the first base is the TAC base 14. One surface of the TAC base 14 is subjected to a saponification treatment and thus the affinity for the adhesive is improved. In the present invention, the material of the first base is not limited to TAC. Examples of other materials of the first base include acrylic resin, COP, PET, and COC. In the present invention, the shape of the first base is not particularly limited. Melt-molded articles such as films, sheets, injection molded articles, and press molded articles are exemplified. The thickness of the TAC base 14 is suitably 40 to 80 μm.

In the first embodiment, the second base is the acrylic base 12. Specific examples of the acrylic base 12 include ACRYVIEWA (manufactured by NIPPON SHOKUBAI CO., LTD.) and TECHNOLLOY (manufactured by Sumitomo Chemical Company, Limited). The shape of the acrylic base 12 is not particularly limited. Melt-molded articles such as films, sheets, injection molded articles, and press molded articles are exemplified. The thickness of the acrylic base 12 is suitably 40 to 80 μm.

In the first embodiment, the polarizing film 13 is formed of a polyvinyl alcohol (PVA)-based film to which an iodine complex or a dichromatic dye is adsorbed and has a characteristic of converting natural light into polarized light which oscillates in a particular direction. The polarizing film 13 is sandwiched between the TAC base 14 and the acrylic base 12. The thickness of the polarizing film 13 is suitably 20 μm.

An example of a method for forming the hydrophilic film 16 is a method in which a mixed solution containing a silicone resin component as a main agent and prepared by mixing a ketone solvent such as methyl ethyl ketone (MEK) or an aromatic solvent such as toluene and an alcohol solvent such as butanol is applied onto one surface of the acrylic base 12 and dried, and then an aqueous adhesive 15 is applied thereon. The molar ratio of the ketone solvent and the alcohol solvent is most preferably 1:1. When the molar ratio is in the range of 1:10 to 10:1, sufficient effects are produced. The thickness of the adhesive 15 is suitably 1.0 to 2.0 μm. According to this method, the hydrophilic film 16 is completely dried and then the polarizing film 13 is laminated. Therefore, the top-layer portion of the polarizing film 13 is not necessarily melted and swollen by the solvent to an extent that the top-layer portion visually becomes cloudy as before and thus the polarizing film 13 is not damaged. Furthermore, since a special adhesive is not used, there are few disadvantages in the production. An example of the main agent is suitably a melamine cross-linked silicone-modified acrylic polymer (trade name: Bell Clean manufactured by NOF CORPORATION). In addition, silicone varnish for coating and silicone-modified varnish can also be used. The above-described hybrid paint may also be used. Components contained in the hydrophilic film 16 can be detected by infrared spectroscopy (IR) or energy dispersive X-ray spectroscopy (EDX).

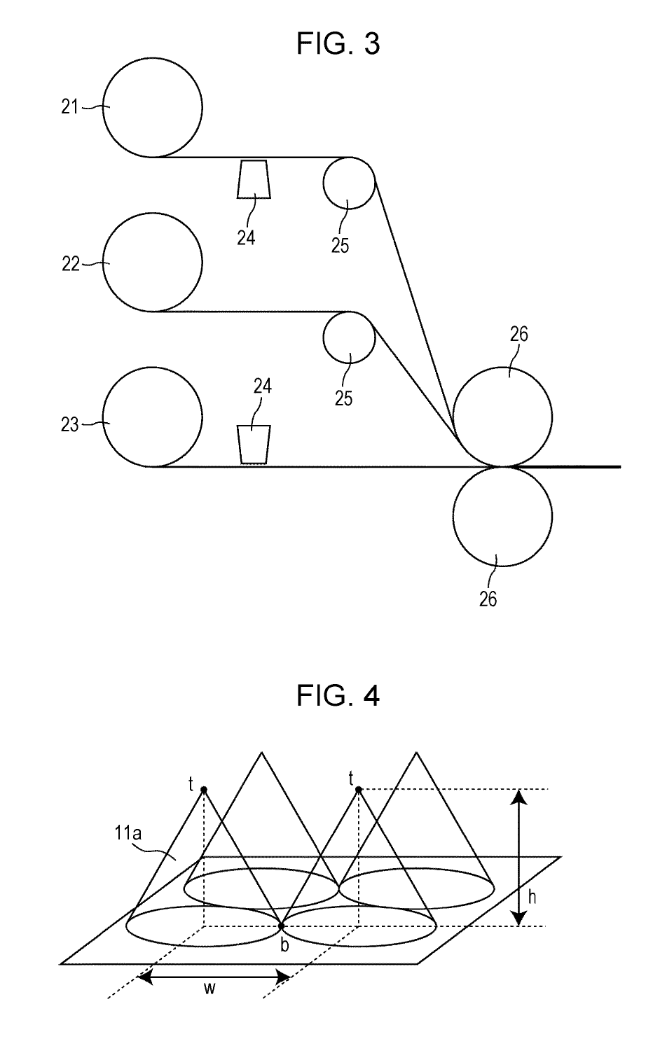

FIG. 3 is a schematic view showing a roll-to-roll process in which a polarizing plate is produced by laminating a TAC base, a polarizing film, and an acrylic base including a moth-eye film on its surface. In the example shown in FIG. 3, three types of rolls are prepared: a first roll 21 around which the acrylic base (second base) including the moth-eye film on its surface is coiled, a second roll 22 around which the polarizing film is coiled, and a third roll 23 around which the TAC film (first base) is coiled. A film drawn from the third roll 23, a film drawn from the second roll 22, and a film drawn from the first roll 21 are laminated with each other in that order from the bottom using an adhesive. The adhesive is discharged from die coaters 24 and applied onto the bottom of the film drawn from the first roll 21 and the top of the film drawn from the first roll 21. The film drawn from the third roll 23 located at the lowermost position is slid at the same level. The second roll 22 and the first roll 21 are disposed at higher positions than the third roll 23 in advance, and the films drawn from the second roll 22 and first roll 21 are guided to an appropriate position through pinch rolls 25.

The films drawn from the three types of rolls are laid on top of one another and brought into a portion between a pair of cylindrical members 26. A drying step (e.g., 80° C. for 60 minutes) for volatilizing components contained in the PVA film and adhesive is performed to complete a polarizing plate whose surface has a moth-eye structure.

In the first embodiment, the moth-eye film is directly bonded to the acrylic base without disposing other members therebetween. Thus, it is possible to avoid an inefficient production process due to the requirement of a margin caused by the formation of a hard coat layer, and it is possible to avoid the moth-eye film not being able to be produced by a roll-to-roll process.

The moth-eye film 11 will now be described in detail. As shown in FIG. 1, the surface of the moth-eye film (anti-reflection film) 11 has a structure including a plurality of protruding portions 11 arranged so that the distance (the width of adjacent protruding portions in the case of an aperiodic structure) or pitch (the width of adjacent protruding portions in the case of a periodic structure) between peaks of adjacent protruding portions is less than or equal to a wavelength of visible light. The width between peaks of adjacent protruding portions is 380 nm or less (less than or equal to a wavelength of visible light). In other words, a plurality of protruding portions are arranged on the surface of the moth-eye film 11 at a distance or pitch of 380 nm or less. The protruding portions in the first embodiment preferably do not have a regular arrangement (have an aperiodic arrangement) because unwanted diffracted light is not generated.

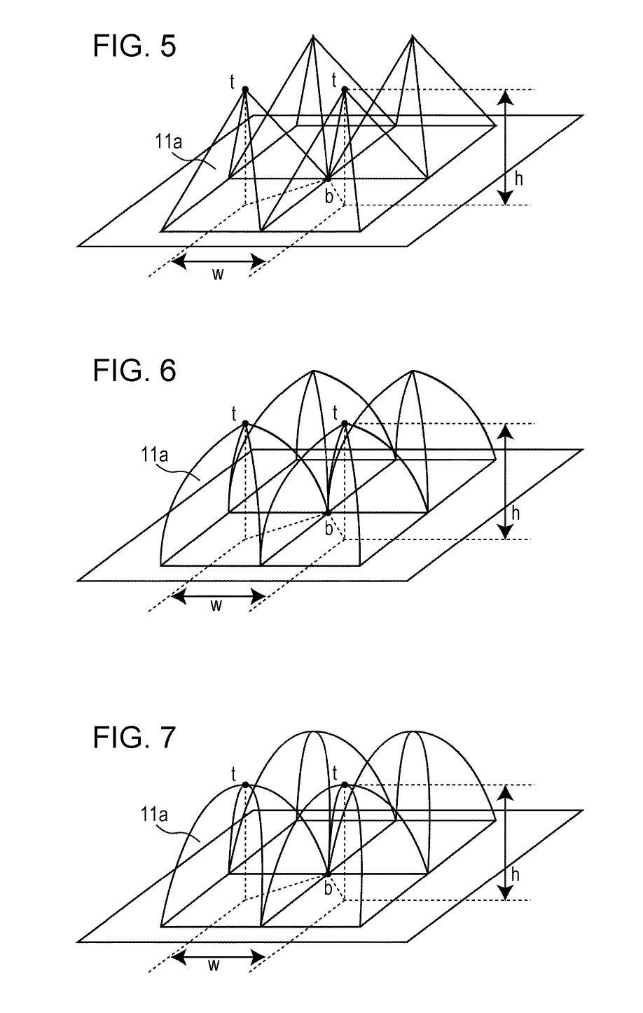

FIGS. 4 and 5 are schematic perspective views of the moth-eye film according to the first embodiment. FIG. 4 shows the case where the unit structure of the protruding portions has a cone shape. FIG. 5 shows the case where the unit structure of the protruding portions has a quadrangular pyramid shape. As shown in FIGS. 4 and 5, the top of each of protruding portions 11a is a peak t and the point at which the protruding portions 11a are in contact with each other is a bottom point b. As shown in FIGS. 4 and 5, the width w between peaks of adjacent protruding portions 11a is indicated by a distance between two points obtained when perpendicular lines are drawn from the peaks t of the protruding portions 11a to the same plane. The height h from the peak to the bottom point of each of the protruding portions 11a is indicated by a length of the perpendicular line drawn from the peak t of the protruding portion 11a to a plane in which the bottom point b is located.

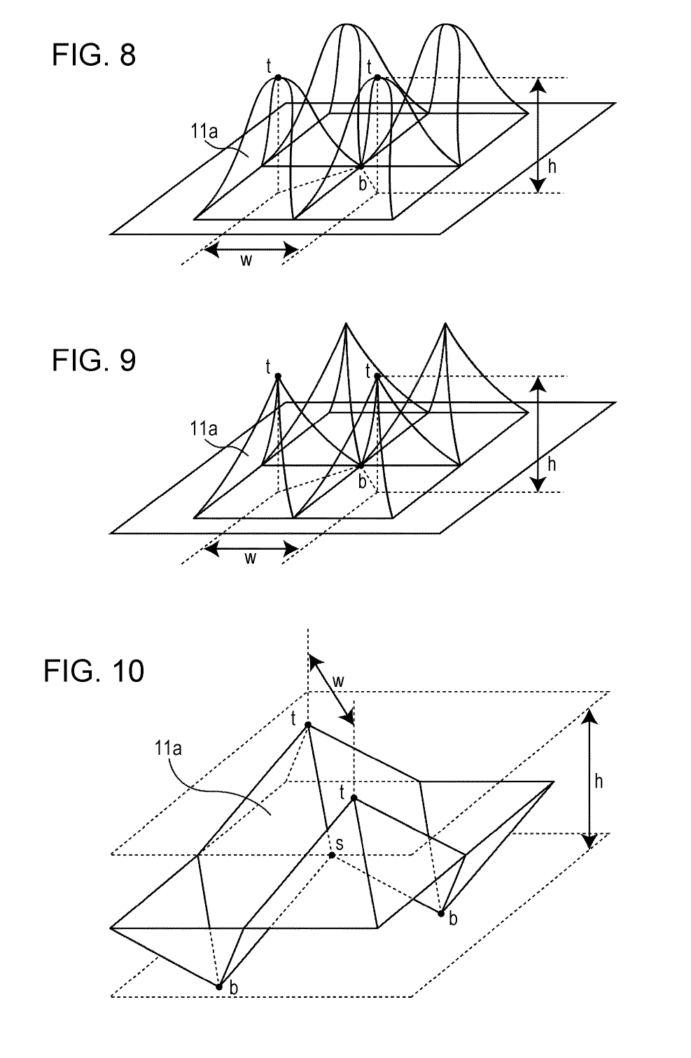

In the moth-eye film of the first embodiment, the width w between peaks of adjacent protruding portions 11a is 380 nm or less, preferably 300 nm or less, and more preferably 200 nm or less. In FIGS. 4 and 5, a cone shape and a quadrangular pyramid shape are exemplified as the shape of the unit structure of the protruding portions 11a. However, the unit structure is not particularly limited as long as the surface of the moth-eye film of the first embodiment has a structure in which the peaks and bottom points are formed and the distance or pitch of the protruding portions is controlled to be lower than or equal to a wavelength of visible light. For example, the unit structure may have a shape in which the inclination decreases in the direction from the bottom point to the peak as shown in FIGS. 6 and 7 (hanging bell type, bell type, or dome type), a shape in which the inclination increases in a region between the bottom point and the peak as shown in FIG. 8 (sine type), or a shape in which the inclination increases in the direction from the bottom point to the peak as shown in FIG. 9 (needle type or tent type). Alternatively, stair-like steps may be formed in the slope.

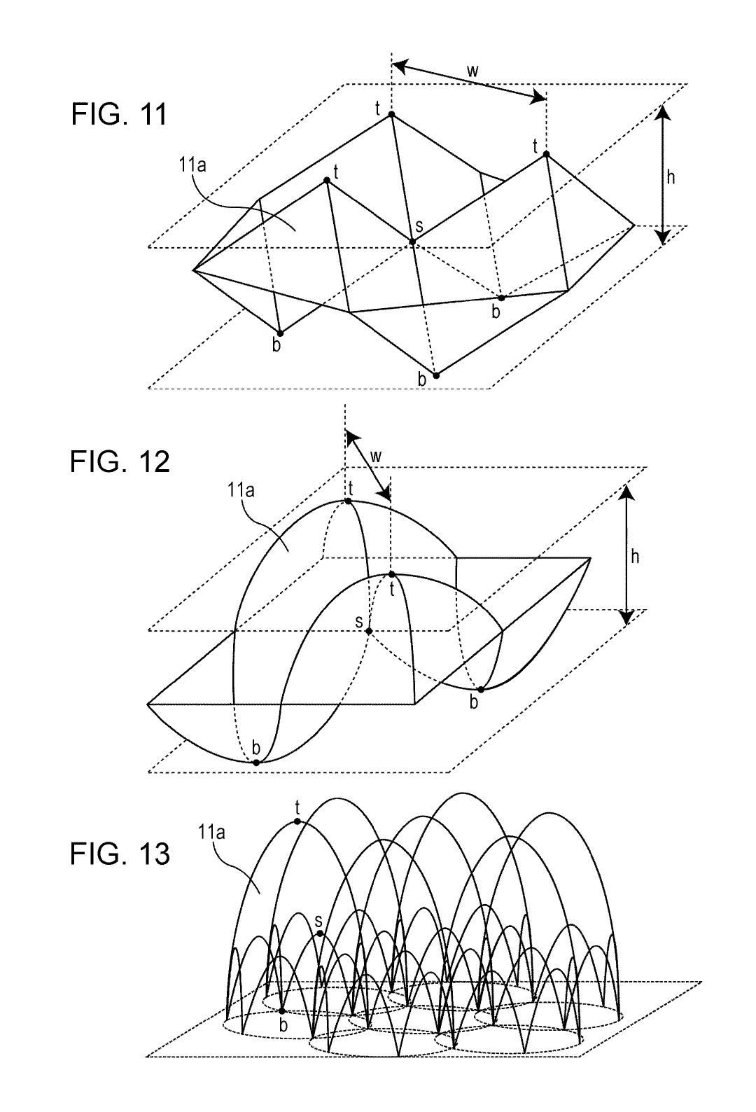

In the first embodiment, the protruding portions may have a plurality of arrangements or may not be arranged. That is, the bottom points, which are points at which the protruding portions 11a are in contact with each other, between adjacent protruding portions are not necessarily present at the same level. For example, as shown in FIGS. 10 to 12, points (contact points) on a surface at which the protruding portions 11a are in contact with each other may be at different levels. Herein, there are saddles in this form. The term “saddle” means a depressed portion along a ridgeline of a mountain (Kojien 5th Edition). When attention is given to a single protruding portion having a peak t, a plurality of contact points are present at positions lower than that of the peak and form saddles. In this specification, a contact point located at the lowermost position around a particular protruding portion is defined as a bottom point b. A point that is located at a position lower than that of the peak t but higher than that of the bottom point b and that serves as an equilibrium point of saddles is defined as a saddle point s. In this case, the width w between peaks of the protruding portions 11a corresponds to the distance between adjacent peaks, and the height h corresponds to the distance from the peak to the bottom point in a vertical direction.

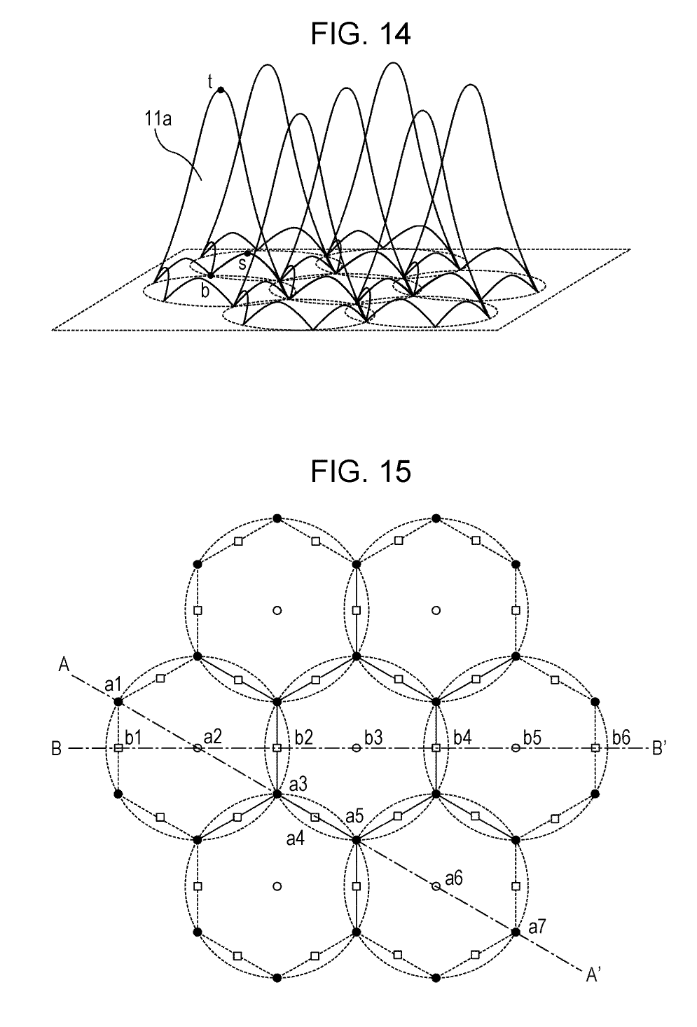

This is more specifically described. In particular, there is shown the case where, when attention is given to a single protruding portion having a peak t, there are a plurality of contact points of adjacent protruding portions and saddles (saddle points) are formed at a position lower than that of the peak t. FIGS. 13 and 14 are schematic perspective views showing the protruding portions of the moth-eye film in detail. FIG. 13 is an enlarged view showing the case where hanging bell-type protruding portions have saddles and saddle points. FIG. 14 is an enlarged view showing the case where needle-type protruding portions have saddles and saddle points. As shown in FIGS. 13 and 14, there are a plurality of contact points of adjacent protruding portions at positions lower than that of one peak t of a protruding portion 11a, that is, there are saddles. As is clear from the comparison between the hanging bell type shown in FIG. 13 and the needle type shown in FIG. 14, the saddles tend to be formed at higher positions in the hanging bell-type protruding portions.

FIG. 15 is a schematic plan view in which the projections and depressions of the moth-eye structure are enlarged. In FIG. 15, a solid-white circle indicates a peak, a solid-black circle indicates a bottom point, and a solid-white square indicates a saddle point of a saddle. As shown in FIG. 15, bottom points and saddle points are formed along concentric circles drawn about one peak serving as the center. FIG. 15 schematically shows circles on which six bottom points and six saddle points are formed, but the protruding portions are not limited thereto and more irregularly arranged protruding portions may be employed.

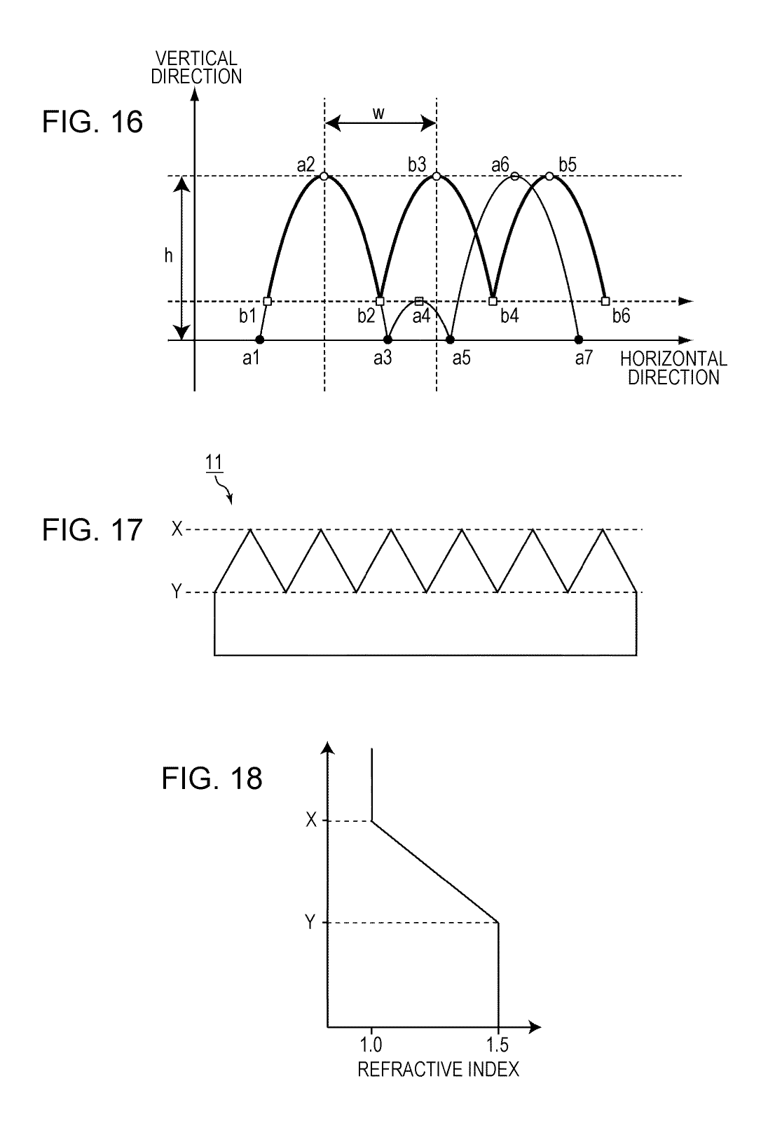

FIG. 16 is a schematic view showing a section taken along line A-A′ in FIG. 15 and a section taken along line B-B′ in FIG. 15. The peaks are denoted by a2, b3, a6, and b5; the saddles are denoted by b1, b2, a4, b4, and b6; and the bottom points are denoted by a1, a3, a5, and a7. Herein, the relationship between a2 and b3 and the relationship between b3 and b5 correspond to the relationship between adjacent peaks. The distance between a2 and b3 and the distance between b3 and b5 correspond to the distance w between adjacent peaks. The height between a2 and a1 or a3 and the height between a6 and a5 or a7 correspond to the height h of the protruding portions.

The principle through which the moth-eye film of the first embodiment can achieve low reflection will now be described. FIGS. 17 and 18 are schematic views showing the principle through which the moth-eye film of the first embodiment can achieve low reflection. FIG. 17 shows a sectional structure of the moth-eye film and FIG. 18 shows the change in refractive index (effective refractive index) that light incident upon the moth-eye film undergoes. When light travels from a certain medium to a different medium, the light is refracted, transmitted, and reflected at the interface between these media. The degree of refraction or the like is determined by the refractive index of a medium through which the light travels. For example, the air has a refractive index of about 1.0 and a resin has a refractive index of about 1.5. In the first embodiment, the unit structure of the irregular structure formed on the surface of the moth-eye film 11 has a substantially cone shape, that is, a shape in which the width gradually decreases toward the edge. Therefore, as shown in FIGS. 17 and 18, it can be regarded that, in a protruding portion (X-Y) located at the interface between the air layer and the moth-eye film 11, the refractive index gradually and continuously increases from about 1.0, which is the refractive index of air, to the refractive index of a material constituting the moth-eye film (about 1.5 if the material is a resin). The amount of light reflected is dependent on the difference in refractive index between media. Therefore, when the interface at which light is refracted is substantially not present in a pseudo manner, most of light is transmitted through the moth-eye film 11, which considerably decreases the reflectance at the surface of the film. FIG. 17 shows a substantially cone-shaped irregular structure as an example, but the structure is not limited thereto as long as an irregular structure that produces a moth-eye anti-reflection effect based on the above principle is employed.

An example of a suitable profile of the plurality of protruding portions constituting the surface of the moth-eye film 11 is described below. That is, the width (distance or pitch) between adjacent protruding portions is 50 nm or more and 200 nm or less and the height of the protruding portions is 50 nm or more and 400 nm or less. FIGS. 4 to 17 show the structure in which the plurality of protruding portions 11a are arranged so as to have a periodic repeating unit at a distance less than or equal to a wavelength of visible light on the whole. However, the protruding portions 11a may partly have an aperiodic arrangement or may have an aperiodic arrangement on the whole. The width between one particular protruding portion among the plurality of protruding portions and a plurality of protruding portions adjacent to the particular protruding portion may be different. In an aperiodic structure, there are advantages in terms of performance and production. Regarding the performance, the diffraction scattering of transmission and reflection due to an regular arrangement is not easily caused. Regarding the production, the pattern can be easily produced. Furthermore, as shown in FIGS. 10 to 16, in the moth-eye film 11, a plurality of bottom points having different heights may be formed around one protruding portion. Note that the surface of the moth-eye film 11 may have depressions and projections having a size larger than a micrometer order, which are larger than the nano-order depressions and projections, that is, may have a double irregular structure.

Examples of a material of the moth-eye film transferring resin include photo-curable resin compositions, active energy ray-curable resin compositions such as electron beam-curable resin compositions, and thermosetting resin compositions.

Among them, (meth)acrylic polymerizable compositions are suitably used. In particular, a urethane (meth)acrylate having a urethane bond in its molecule, an ester (meth)acrylate having an ester bond in its molecule, and an epoxy (meth)acrylate having an epoxy group in its molecule are suitably used.

When the transferring resin is a photo-curable resin composition, a photopolymerization initiator is preferably contained. When the transferring resin is a thermosetting resin composition, a thermal polymerization initiator is preferably contained. The photopolymerization initiator may be an ultraviolet light polymerization initiator having an absorption wavelength in an ultraviolet wavelength range or a visible light polymerization initiator having an absorption wavelength in a visible wavelength range. In consideration of the adverse effect on a polarizer by irradiation with ultraviolet light, a visible light polymerization initiator is preferably used. This results in no need of imparting a UV absorption property to the base.

Specific examples of a method for forming (duplicating) fine depressions and projections on a base using a die include a photopolymerization method (2P method) in which depressions and projections are transferred while at the same time irradiation with light is performed to cure a resin; a duplicating method such as a hot pressing method (embossing method), an injection molding method, or a sol-gel method; a laminating method of a fine-irregularity-forming sheet; and a transferring method of a fine irregular layer. These methods may be suitably selected in accordance with the applications of an anti-reflective article and the materials of a base.

The depth of depressed portions in the die and the height of protruding portions in the moth-eye film can be measured using a scanning electron microscope (SEM). Note that, in reality, the depth of depressed portions in the die and the height of protruding portions in the moth-eye film are different from each other in a strict sense and the depth of depressed portions in the die is generally larger. The ratio of the height of protruding portions in the moth-eye film to the depth of depressed portions in the die is also referred to as a packing fraction.

### Example 1

A method for producing a laminate including a moth-eye film and an acrylic base in the polarizing plate of the first embodiment will now be described in detail based on an actually produced sample (Example 1). The results of characteristic evaluation tests in Example 1 are also shown.

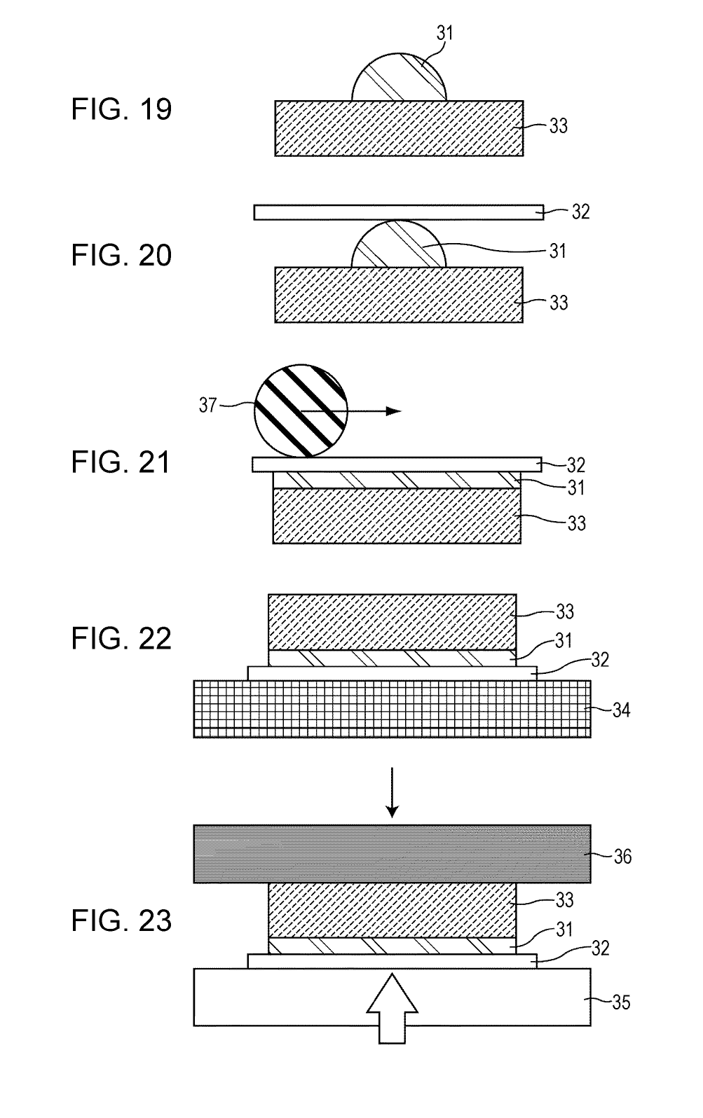

FIGS. 19 to 24 are schematic views each showing a step in a production process of a polarizing plate in Example 1. In Example 1, a transferring resin layer was formed by dropping an undiluted solution for transferring resin onto a die and performing heating at a certain temperature or more while pressing the die.

First, as shown in FIG. 19, a droplet of an undiluted solution (solventless) of a transferring resin 31 to be formed into a moth-eye film was dropped onto a glass die whose surface had an aluminum anodic oxidation film. Subsequently, as shown in FIG. 20, an acrylic base 32 (manufactured by Sumitomo Chemical Technolloy) was laid on top of the droplet of the transferring resin 31. As shown in FIG. 21, the droplet was drawn on the die 33 using a hand roller 37 to form a layer having a uniform thickness of about 10 μm.

A die for forming nano-order depressions and projections on the transferring resin was separately produced. First, a glass substrate having a size of 40 mm×40 mm was prepared and an aluminum (Al) film having a thickness of 1.0 μm was formed on the glass substrate by sputtering. The aluminum film was then anodized and immediately etched. This process was repeatedly performed to form many fine holes in the surface of the aluminum film so that the distance between bottom points of adjacent holes (depressed portions) was less than or equal to a wavelength of visible light. Specifically, anodization, etching, anodization, etching, anodization, etching, anodization, etching, and anodization were performed in that order (five times of anodization and four times of etching) to make the holes described above. By continuously performing this repetitive process of anodization and etching without intervals, abnormally grown particles are formed and thus fine holes having a tapered shape whose width decreases toward the inside of the aluminum film were made. The anodization was performed using 0.6 wt % oxalic acid at a liquid temperature of 5° C. at an application voltage of 80 V. By adjusting the time for the anodization, the size (depth) of the formed holes is differentiated. The etching in each example was performed using 1 mol/l phosphoric acid at a liquid temperature of 30° C. for 25 minutes.

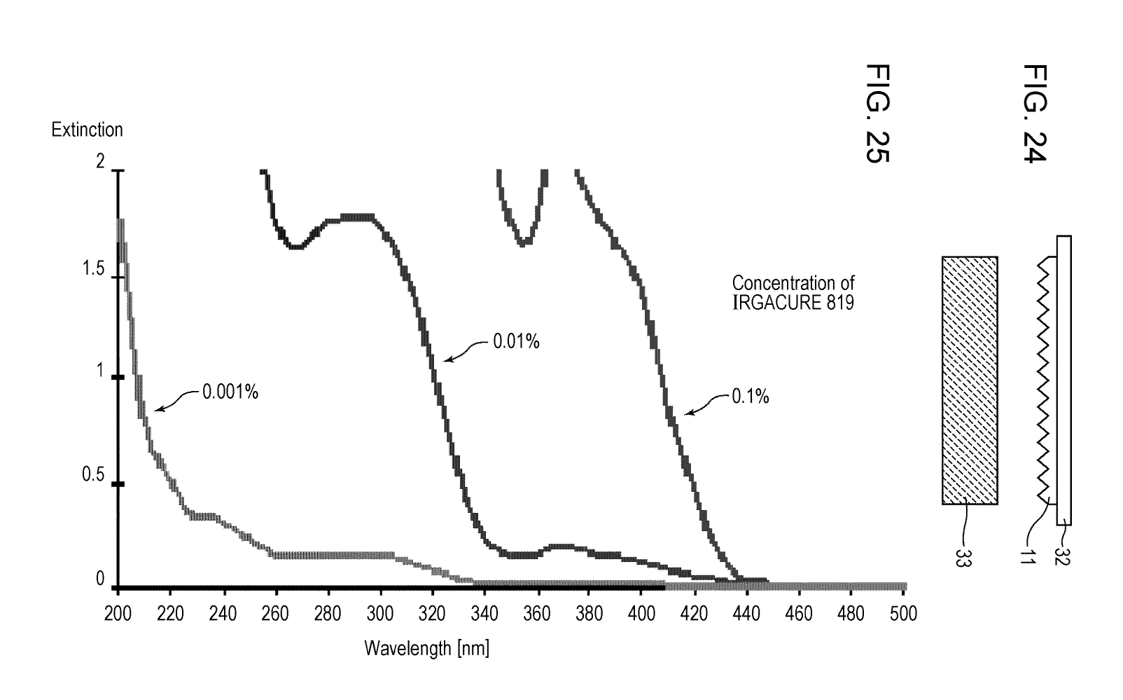

As shown in FIG. 22, the laminate including the acrylic base 32 and the transferring resin 31 was then placed on a hot plate 34 so that the acrylic base 32 faced the hot plate 34 to perform a drying process. Subsequently, as shown in FIG. 23, the laminate was placed on a quartz base 35 so that the acrylic base 32 faced the quartz base 35. A load (200 kg, 30 seconds) was applied to the laminate from the die 33 side using a pressing machine 36 to transfer the surface profile of the die 33 onto the transferring resin 31. At the same time, the laminate was irradiated with ultraviolet light (30 mW/cm²) from the quartz base 35 side using a high-pressure mercury lamp for 30 seconds and then left to stand for 20 seconds to cure the transferring resin 31. As shown in FIG. 24, the acrylic base 32 and the moth-eye film 11 were detached from the die 33 to complete a laminate sample including no member between the acrylic base 32 and the moth-eye film 11.

When a photo-curable resin is used as a material of the transferring resin, a photopolymerization initiator is preferably added. The photopolymerization initiator is suitably a visible light polymerization initiator A (trade name: IRGACURE 819 manufactured by BASF) represented by chemical formula (1) below

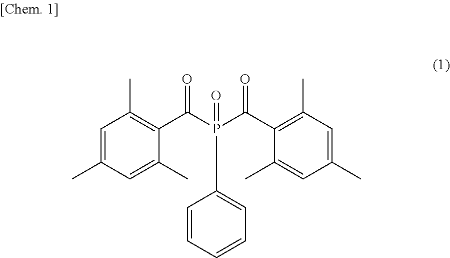

or a visible light polymerization initiator B (trade name: IRGACURE 1800 manufactured by BASF) containing a compound a represented by chemical formula (2) below

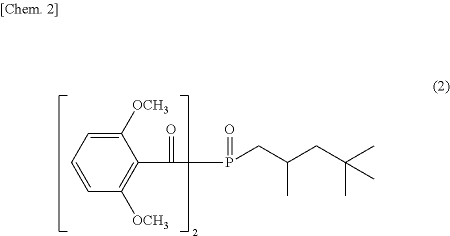

and a compound b represented by chemical formula (3) below

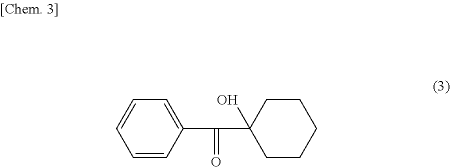 [SMILES: O=C(c1ccccc1)C1(O)CCCCC1]

so that compound a:compound b=1:3 on a weight basis is satisfied.

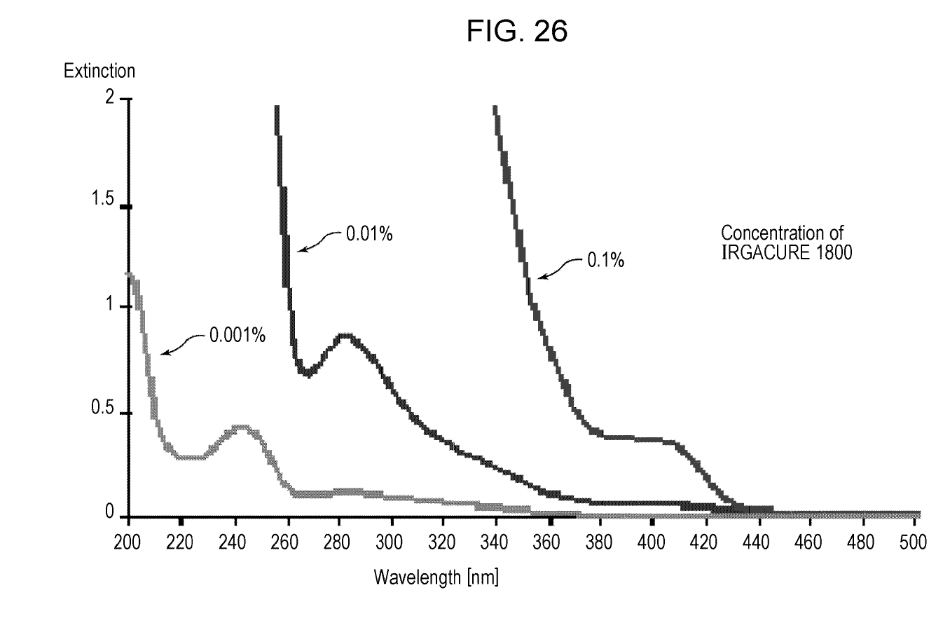

FIG. 25 is a graph showing the absorption characteristics of the visible light polymerization initiator A. FIG. 26 is a graph showing the absorption characteristics of the visible light polymerization initiator B.

As shown in FIG. 25, at least when the weight ratio of the visible light polymerization initiator A to the transferring resin (solventless) is 0.01 wt % or more, the absorption characteristics are slightly exhibited in a visible light wavelength range. When the weight ratio is 0.1 wt % or more, high absorption characteristics are exhibited. In contrast, at least when the weight ratio of the visible light polymerization initiator A to the transferring resin (solventless) is 0.001 wt % or less, the absorption characteristics are not exhibited in a visible light wavelength range.

As shown in FIG. 26, at least when the weight ratio of the visible light polymerization initiator B to the transferring resin (solventless) is 0.01 wt % or more, the absorption characteristics are also slightly exhibited in a visible light wavelength range. When the weight ratio is 0.1 wt % or more, high absorption characteristics are exhibited. In contrast, at least when the weight ratio of the visible light polymerization initiator B to the transferring resin (solventless) is 0.001 wt % or less, the absorption characteristics are not exhibited in a visible light wavelength range.

When the visible light polymerization initiator A or the visible light polymerization initiator B is used and the weight ratio is a certain ratio or more, curing of the transferring resin can be facilitated using not only ultraviolet light but also visible light.

In Example 1, the (meth)acrylic polymerizable composition was used as the transferring resin and the visible light polymerization initiator B was used as the photopolymerization initiator.

Regarding the thus-produced sample (the laminate including the moth-eye film and acrylic base), the adhesiveness between the acrylic base and the moth-eye film was checked using a cross-cut test based on JIS K 5600-5-6. Table 1 shows the results.

TABLE 1

| | | Heating time | | |
|---|---|---|---|---|
| | | 10 sec | 30 sec | 3 min |
| Heating | 60° C. | 0/100 | 100/100 | 94/100 |
| temperature | 80° C. | 0/100 | 100/100 | 100/100 |
| | 100° C. | 0/100 | 99/100 | 98/100 |

As shown in Table 1, good adhesiveness was achieved at any of heating temperatures of 60° C., 80° C., and 100° C. by at least performing heating for 30 seconds or longer. In contrast, when the heating time was 10 seconds or shorter, sufficient adhesiveness was not achieved.

Even when the heating was performed at 100° C., which was the highest temperature, for 3 minutes, which was the longest time, the ultraviolet-curing property was not adversely affected. Furthermore, there was no problem concerning the heat resistance (specifically shrinkage and the like) of the acrylic base in all the samples.

Subsequently, characteristic evaluation tests of the moth-eye film were conducted. Specific evaluation methods were (1) film thickness measurement, (2) shape observation with SEM, (3) measurement of reflectance, (4) pencil hardness test, (5) steel wool (SW) test, and (6) fingerprint wipe-off property.

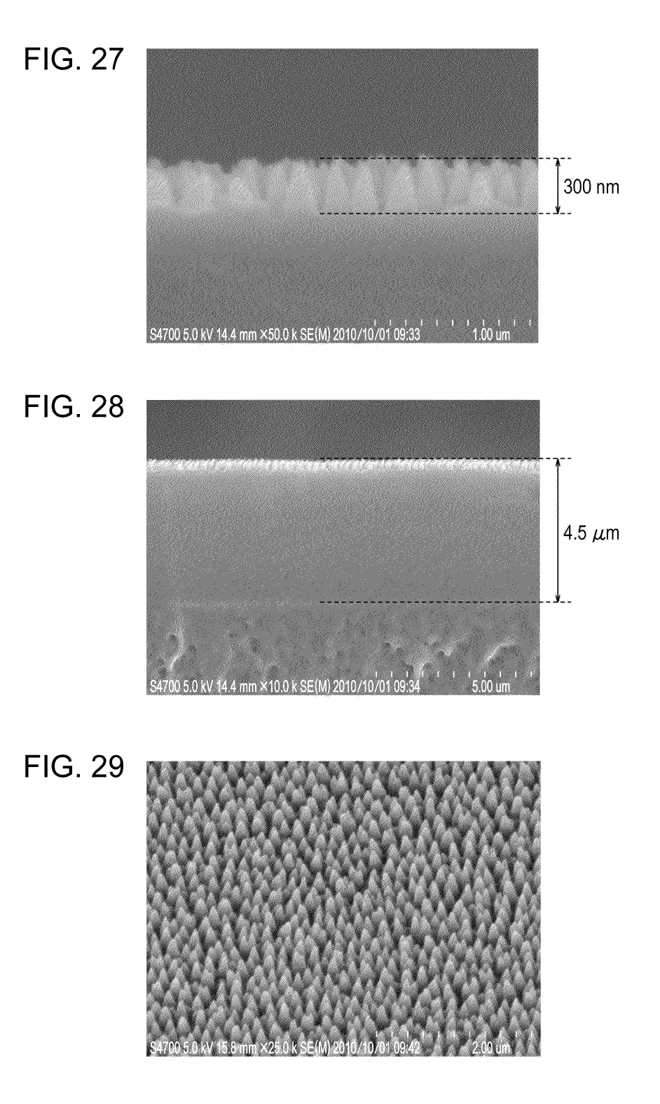

FIG. 27 is a photograph showing the result provided by checking the height of protruding portions of the moth-eye film. FIG. 28 is a photograph showing the result provided by checking the thickness of the moth-eye film. FIG. 29 is a photograph that was taken from diagonally above and shows the surface structure of the moth-eye film. As shown in FIGS. 27 to 29, each of the protruding portions had a substantially uniform height of 280 to 320 nm. The moth-eye film had a thickness of 4 to 5 μm. Furthermore, immediately after the transferring, the protruding portions on the surface of the moth-eye film were each independently present and a so-called sticking structure in which the edges of the protruding portions are bent and connected to each other to form a bundle (bridge) was not formed.

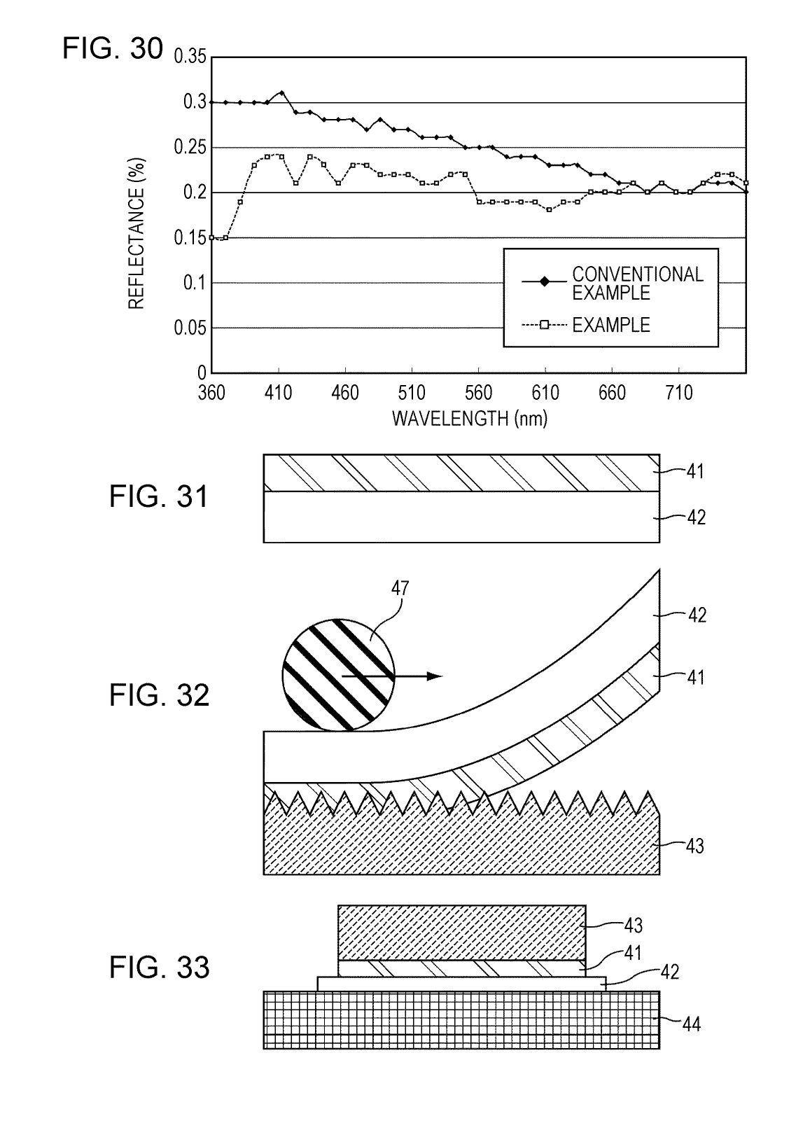

The reflectance of the sample heated at 60° C. for 30 seconds among the produced samples was determined. The reflectance was measured with a spectrophotometer CM-2600d (SCI mode) manufactured by KONICA MINOLTA, INC. FIG. 30 shows the measurement results of the reflectance. An upper graph in FIG. 30 indicates the reflectance of a known laminate produced by laminating a TAC base, a hard coat layer, and a moth-eye film. A lower graph in FIG. 30 indicates the reflectance of the laminate produced by laminating an acrylic base and a moth-eye film in Example 1. As is clear from FIG. 30, even when an acrylic base is used as a base and a hard coat layer is not formed, there is no significant change in reflectance and a moth-eye film having sufficient reflectivity is formed.

Other characteristic tests were conducted and the following results were obtained. The packing fraction was 75%, which was a high value compared with common anti-reflection (AR) films that reduce reflection by using light interference. To check the releasability, a comparison was made by the touch at the moment of detachment. Substantially the same touch as the AR film was obtained.

A pencil hardness test was conducted on the sample heated at 80° C. for 30 seconds among the produced samples. Specifically, fine lines were drawn and scars of the five lines were examined. When an HB pencil was used, no scars were observed. When an H pencil was used, scars were left for all the five lines. Thus, it was found that the above sample had HB resistance.

A steel wool (SW) (400 g) resistance test was conducted on the sample heated at 80° C. for 30 seconds among the produced samples. Specifically, rubbing with steel wool was performed with ten outward-and-returning motions in total. Herein, one second was taken for a single outward-and-returning motion. The evaluation was conducted through visual inspection based on whether the number of scars was five or less. The SW resistance was evaluated while the sample was attached to a black acrylic plate.

A fingerprint wipe-off property was examined on the sample heated at 80° C. for 30 seconds among the produced samples. The test method was as follows. Three types of wiping actions, that is, wiping with a dry cloth, wiping with a damp cloth, and wiping with a cleaner were performed on a sample marked with fingerprints (water and fat) and residual fingerprints were observed through visual inspection. A neutral detergent diluted to 1% was used as the cleaner. In wiping with a cleaner, wiping with a damp cloth was performed after the wiping with a cleaner. As a result, the fingerprints were not sufficiently wiped off by the wiping with a dry cloth, but were able to be wiped off by the wiping with a damp cloth or the wiping with a cleaner.

### Example 2

A method for producing a laminate including a moth-eye film and an acrylic base in the polarizing plate of the first embodiment will now be described in detail based on an actually produced sample (Example 2). The results of characteristic evaluation tests of the samples in Example 2 are also shown.

FIGS. 31 to 35 are schematic views each showing a step in a production process of a polarizing plate in Example 2. In Example 2, a transferring resin layer was formed by applying a mixture of a solid component of the transferring resin with a solvent onto an acrylic base and then performing heating at a certain temperature or more.

A method for forming the moth-eye film on the acrylic base will be described. First, as shown in FIG. 31, a mixture containing a solid component of a transferring resin 41 and methyl ethyl ketone (MEK) at a molar ratio of 1:1 was applied onto an acrylic base 42 (manufactured by Sumitomo Chemical Technolloy) to form a transferring resin 41 having a thickness of 10 μm.

A die for forming nano-order depressions and projections on the transferring resin was separately produced. First, a glass substrate having a size of 40 mm×40 mm was prepared and an aluminum (Al) film having a thickness of 1.0 μm was formed on the glass substrate by sputtering. The aluminum film was then anodized and immediately etched. This process was repeatedly performed to form many fine holes in the surface of the aluminum film so that the distance between bottom points of adjacent holes (depressed portions) was less than or equal to a wavelength of visible light. Specifically, anodization, etching, anodization, etching, anodization, etching, anodization, etching, and anodization were performed in that order (five times of anodization and four times of etching) to make the holes described above. By continuously performing this repetitive process of anodization and etching without intervals, abnormally grown particles are formed and thus fine holes having a tapered shape whose width decreases toward the inside of the aluminum film were made. The anodization was performed using 0.6 wt % oxalic acid at a liquid temperature of 5° C. at an application voltage of 80 V. By adjusting the time for the anodization, the size (depth) of the formed holes is differentiated. The etching in each example was performed using 1 mol/l phosphoric acid at a liquid temperature of 30° C. for 25 minutes.

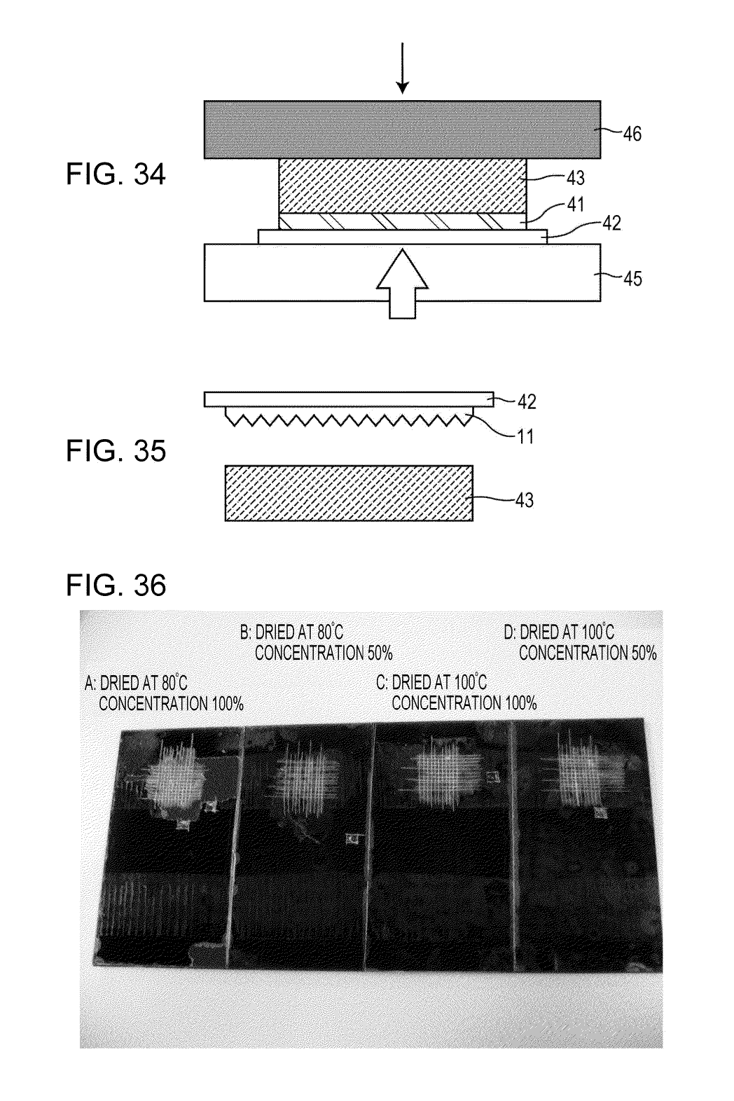

As shown in FIG. 32, the droplet was drawn on a die 43 using a hand roller 47 to form a layer having a uniform thickness. Subsequently, as shown in FIG. 33, the laminate including the die 43, the transferring resin 41, and the acrylic base 42 was placed on a hot plate 44 so that the acrylic base 42 faced the hot plate 44 to perform a drying process. Subsequently, as shown in FIG. 34, the laminate including the die 43, the transferring resin 41, and the acrylic base 42 was placed on a quartz base 45 so that the acrylic base 42 faced the quartz base 45. A load (200 kg, 30 seconds) was applied to the laminate from the die 43 side using a pressing machine 46 to transfer the surface profile of the die 43 onto the transferring resin 41. At the same time, the laminate was irradiated with ultraviolet light from the quartz base 45 side and then left to stand for 20 seconds to cure the transferring resin 41. As shown in FIG. 35, the laminate including the acrylic base 42 and the moth-eye film 11 were detached from the die 43 to complete a laminate sample including no member between the acrylic base 42 and the moth-eye film 11.

In Examples 1 and 2, the moth-eye film 11 had a thickness of 4 to 5 μm. According to the method of Example 2 in which the adhesiveness with the acrylic base is improved by using a solvent, the thickness of the moth-eye film can be decreased to 1 μm at the minimum. The thickness of the acrylic base is preferably 20 to 100 μm. At present, the thickness of the acrylic base is said to be suitably 40 μm. In a current technique, if the thickness of the acrylic base is 20 μm or less, the elasticity of the base is lost and the handling becomes difficult. In addition, curling readily occurs because the thickness of the moth-eye film is larger than that of the acrylic base. In contrast, according to the method of Example 2, the thicknesses of the moth-eye film and acrylic base can be decreased compared with before. Therefore, the handling is improved and the curling is prevented, which is advantageous in terms of the production. Herein, if the thickness of the moth-eye film 11 is decreased to less than 1 μm, no difference is made between the thickness of the moth-eye film and the depth of a transferred structure, which makes it difficult to achieve the detachment. Therefore, the thickness of the moth-eye film needs to be 1 μm or more.

In Example 2, the (meth)acrylic polymerizable composition was used as the transferring resin and the visible light polymerization initiator B was used as the photopolymerization initiator.

In Example 2, the conditions of the samples were set on the basis of the characteristics of the acrylic base, the concentration of the solvent, and the like. The appearance, adhesiveness, and SW resistance of each of the samples were examined. Table 2 below shows the examination results.

TABLE 2

| | | | Thickness | Drying | Resin | UV |
|---|---|---|---|---|---|---|
| Sample No. | | Resin | of base | conditions | concentration | exposure |
| 1 | | Hydrophilic | 125 μm | 80° C., 20 sec | 75% | Normal |
| 2 | | acrylic resin | | | 50% | Normal |
| 3 | A | (with ether | | 80° C., 40 sec | 100% | Normal |
| 4 | | group in | | | 75% | Normal |
| 5 | B | its main | | | 50% | Normal |
| 6 | | skeleton) | | 80° C., 60 sec | 100% | Normal |
| 7 | | | | | 50% | Normal |
| 8 | | | | 100° C., 20 sec | 100% | Normal |
| 9 | | | | | 75% | Normal |
| 10 | | | | | 50% | Normal |
| 11 | C | | | 100° C., 40 sec | 100% | Normal |
| 12 | | | | | 75% | Normal |
| 13 | D | | | | 50% | Normal |
| 14 | | | 75 μm | 80° C., 40 sec | 50% | Normal |
| 15 | | | | 80° C., 60 sec | 75% | Normal |
| 16 | E | Hydrophobic | 75 μm | 80° C., 40 sec | 100% | Normal |
| 17 | F | acrylic resin | | | 50% | Normal |
| 18 | | | | 100° C., 40 sec | 100% | Normal |
| 19 | | | | | 50% | Normal |
| 20 | G | | | | 100% | 1.5 times |
| 21 | H | | | | 50% | 1.5 times |

Two types of bases such as a base whose surface has hydrophilicity and a base whose surface has hydrophobicity were prepared as the acrylic base 42. Two types of acrylic bases having thicknesses of 75 μm and 125 μm were prepared. The resin concentration (%) in Table 2 is the percentage of the mass ratio calculated based on solid component/(solid component+solvent). Methyl ethyl ketone (MEK) was used as the solvent. The ultraviolet (UV) irradiation was performed using an ultrahigh-pressure mercury lamp as a light source at an integrated amount of light of 1 J/cm². Among the samples listed in Table 2, the samples A to H were subjected to the characteristic evaluation tests. Table 3 shows the results.

TABLE 3

| | | | | | | | | | SW |
|---|---|---|---|---|---|---|---|---|---|
| | | | Thickness | Drying | Resin | UV | | | resistance |
| Sample No. | | Resin | of base | conditions | concentration | exposure | Appearance | Adhesiveness | (400 g) |
| 3 | A | Hydrophilic | 125 μm | 80° C., 40 sec | 100% | Normal | 4 | 12/100 | 4 |
| 5 | B | acrylic resin (with | | | 50% | Normal | 3 | 100/100 | 3 |
| 11 | C | ether group in its | | 100° C., 40 sec | 100% | Normal | 3 | 100/100 | 3 |
| 13 | D | main skeleton) | | | 50% | Normal | 2 | 100/100 | 2 |
| 16 | E | Hydrophobic | 75 μm | 80° C., 40 sec | 100% | Normal | 2 | 15/100 | 2 |
| 17 | F | acrylic resin | | | 50% | Normal | 2 | 48/100 | 1 |
| 20 | G | | | 100° C., 40 sec | 100% | 1.5 times | 1 | 86/100 | 2 |
| 21 | H | | | | 50% | 1.5 times | 1 | 100/100 | 2 |

The film appearance in Table 3 is evaluated in five grades from 5 (good) to 1 (poor). The criteria are specifically described below.

5: There are no clearly observed scars.
4: The number of clearly observed scars is 5 or less.
3: The number of clearly observed scars is 10 or less.
2: The number of clearly observed scars is 30 or less.
1: There are countless clearly observed scars.

The following was found from Table 3. Regarding the correlation between the resin concentration and the film appearance, better appearance was observed as the resin concentration was increased. Regarding the correlation between the drying temperature and the film appearance, better appearance was observed as the drying temperature was decreased.

FIG. 36 is a photograph showing the results of the evaluation test for adhesiveness of the samples A to D that use a hydrophilic acrylic resin. It was found from the comparison between the sample A and the sample B and between the sample C and the sample D that, when the same type of resin was used and the same drying temperature was employed, a larger amount of resin was left on the black acrylic plate as the resin concentration was increased, and thus higher adhesiveness was achieved. It was also found from the comparison between the sample A and the sample C and between the sample B and the sample D that, when the same type of resin was used and the same resin concentration was employed, a larger amount of resin was left on the black acrylic plate as the drying temperature was increased, and thus higher adhesiveness was achieved.

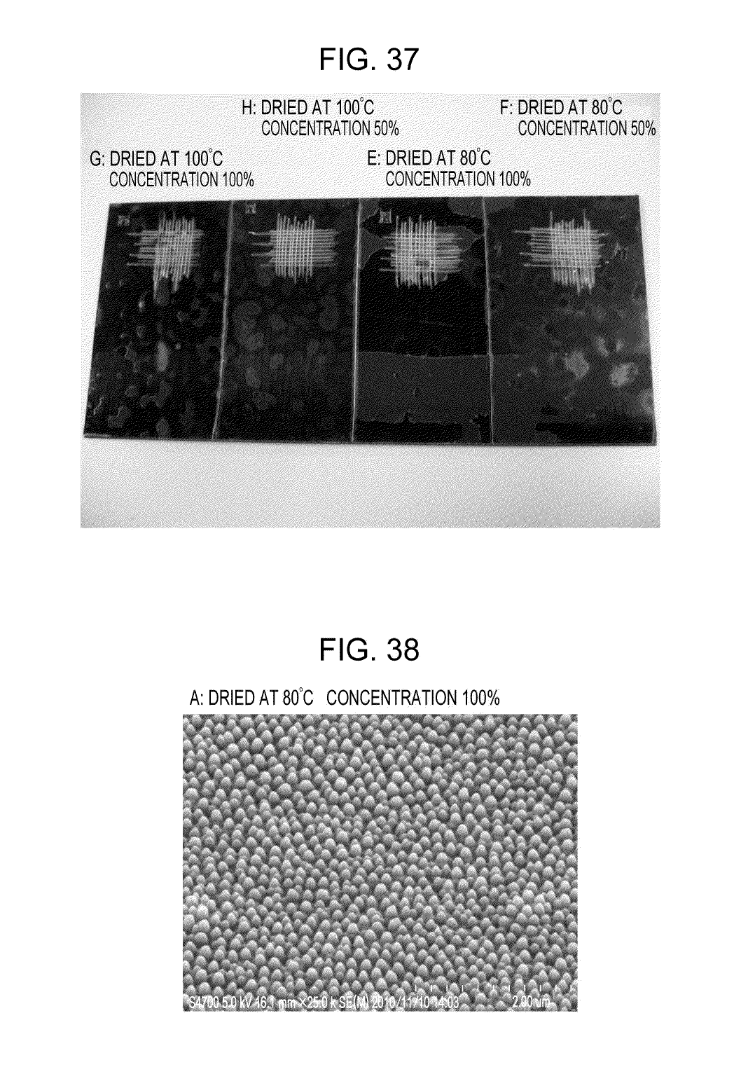

FIG. 37 is a photograph showing the results of the evaluation test for adhesiveness of the samples E to H that use a hydrophobic acrylic resin. It was found from the comparison between the sample E and the sample F and between the sample G and the sample H that, when the same type of resin was used and the same drying temperature was employed, a larger amount of resin was left on the black acrylic plate as the resin concentration was decreased, and thus higher adhesiveness was achieved. It was also found from the comparison between the sample E and the sample G and between the sample F and the sample H that, when the same type of resin was used and the same drying temperature was employed, a larger amount of resin was left on the black acrylic plate as the resin concentration was decreased, and thus higher adhesiveness was achieved.

As described above, it was found that, regardless of any of a hydrophilic material and a hydrophobic material constituting the surface of the acrylic base, higher adhesiveness tended to be achieved as the resin concentration was decreased or as the drying temperature was increased.

It was difficult to evaluate the SW resistance because film defect portions roughened the SW surface. However, it was found from at least the comparison between the hydrophilic resin and the hydrophobic resin that higher resistance was achieved in the hydrophilic resin.

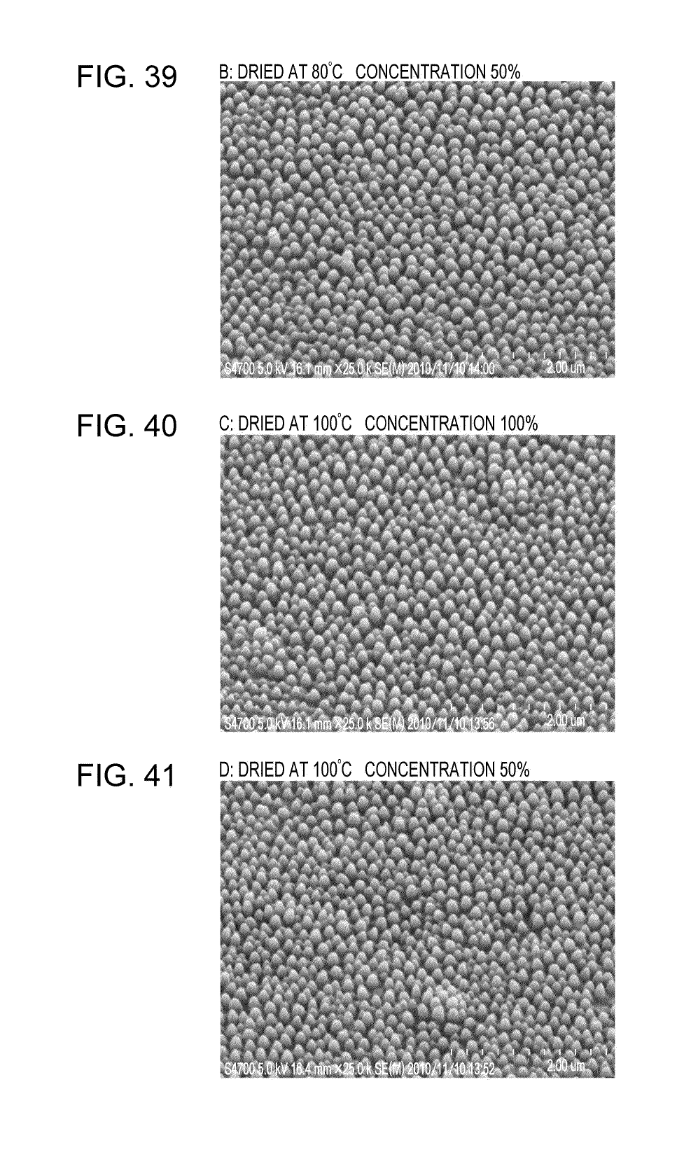

FIGS. 38 to 41 are enlarged photographs of the surfaces of the samples A to D. As is clear from FIGS. 38 to 41, a moth-eye structure was formed in all of the samples.

### Example 3

The laminate of Example 3 and the laminate of Example 2 are the same in that a mixture of a solid component of a transferring resin with a solvent was applied onto an acrylic base and then a film of the transferring resin was formed, but are different in that a droplet was drawn on a die using a hand roller to form a layer having a uniform thickness and then the laminate was placed on a hot plate but a drying process was not performed. Even when such a drying process was not performed, adhesiveness higher than a certain level was achieved by the above mixture and thus the moth-eye film can be directly laminated on the acrylic base. Specific conditions other than the drying process with a hot plate were the same as those of Example 2.

### Example 4

Regarding the polarizing plate of the first embodiment, an example (Example 4) in which a polarizing plate was produced by actually attaching a polarizing film to the laminate including the moth-eye film and acrylic base of Example 2 will now be described in detail. To evaluate the characteristics of the polarizing plate of Example 4, polarizing plates for Reference Example 1 and Comparative Example 1 were also produced, and the characteristics were examined by comparing these polarizing plates.

Subsequently, an example (Example 4) in which a polarizing plate was actually produced by attaching, to a polarizing film, the laminate (Example 2) that included the moth-eye film and acrylic base and was produced as described above will now be described.

The polarizing plate was produced by the roll-to-roll process shown in FIG. 3. Herein, a polarizing plate of Example 4, a polarizing plate of Reference Example 1, and a polarizing plate of Comparative Example 1 each including a base film composed of a different material were produced.

The polarizing plate of Example 4 was produced by the method described in the first embodiment. Specifically, a mixture of Bell Clean (solid content: 50%, manufactured by NOF CORPORATION) serving as a main agent and a mixed solvent containing cyclohexanone and toluene at a molar ratio of 1:1 was applied onto an alkali base by gravure coating to form a hydrophilic film. Subsequently, a drying process was performed on a hot plate at 80° C. for 5 minutes to dry the hydrophilic film. The acrylic base and a polarizing film were then laminated to each other using an aqueous adhesive. On the other surface of the polarizing film, an N-TAC film (manufactured by Fujifilm Corporation) whose surface was subjected to a saponification treatment was laminated using an aqueous adhesive.

### Reference Example 1

In Reference Example 1, a polarizing plate was produced in the same manner as in Example 4, except that a corona treatment was performed instead of the solvent treatment for improving the hydrophilicity in Example 4. The corona treatment was performed at 200 W·min/m².

### Comparative Example 1

Comparative Example 1 is an example of a polarizing plate produced by forming a hard coat layer between a moth-eye film and a TAC base. A UV absorbing-TAC film (manufactured by Fujifilm Corporation) whose surface was subjected to a saponification treatment was used as a base film. The saponification treatment was performed in the order of an alkali treatment, washing with water, an acid treatment, and washing with water. The alkali treatment was performed using a 2 N aqueous sodium hydroxide (NaOH) solution at 50° C. for one minute. The acid treatment was performed using a 1 mol/l aqueous sulfuric acid solution at 25° C. for one minute.

Typical examples of a material of the hard coat layer include thermoplastic resins, thermosetting resins, and photo-curable resins having a hardness higher than or equal to H in a pencil hardness test based on JIS K 5400.

In Comparative Example 1, an ionizing radiation-curable resin (HC-C (CS-530) manufactured by DNP Fine Chemicals Co., Ltd.) was used as a material of the hard coat layer.

The results of the characteristic evaluation tests of the polarizing plates in Example 4, Reference Example 1, and Comparative Example 1 are described below.

First, a test for adhesiveness was conducted. Specifically, a punch test of 10 cm square was performed on each of the produced polarizing plates to check whether or not separation from four corners was caused. The separation means low adhesiveness between the polarizing film and the acrylic base. As a result, the polarizing plates in Example 4 and Comparative Example 1 had high adhesiveness, but the polarizing plate in Reference Example 1 had low adhesiveness.

In each of the polarizing plates, before the polarizing film was laminated, a contact angle of water at the surface of the acrylic base was measured using a contact angle meter. As a result, the contact angle in Example 4 was 30°, the contact angle in Reference Example 1 was 60°, and the contact angle in Comparative Example 1 was 25°.

According to Reference Example 1, the adhesiveness between the moth-eye film and the acrylic base was ensured, but the adhesiveness between the polarizing film and the acrylic base was left as a problem.

According to Comparative Example 1, high adhesiveness between the polarizing film and the acrylic base was achieved, but the following problem arose.

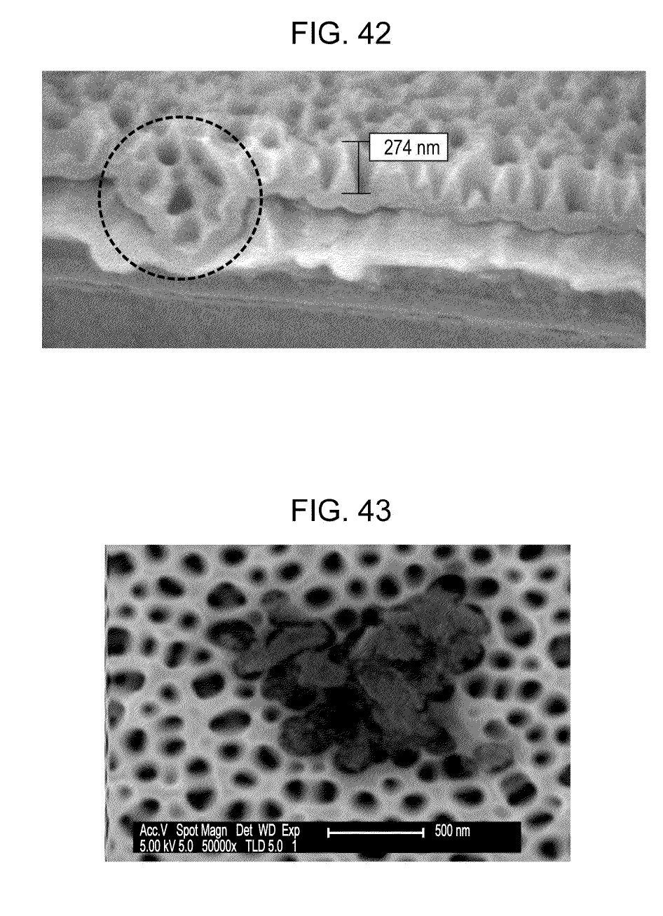

The result of the characteristic evaluation of the polarizing plate in Comparative Example 1 is described below. FIG. 42 is a photograph showing a section near the surface of the die used to produce the sample of Comparative Example 1. FIG. 43 is a photograph showing an upper surface of the die used to produce the sample of Comparative Example 1. The circled region in FIG. 42 is a region that may be clogged with a resin of the hard coat layer when the hard coat layer overlaps the die. The black portion shown in FIG. 43 indicates a resin that caused clogging of the die. The region that may be clogged with a resin has a hole much deeper than surrounding holes. When the aluminum film is not densely formed and has cracks, which are particularly easily formed around abnormally grown particles, the hole tends to be much deeper than surrounding holes.

Such a resin-clogging phenomenon occurred in a region in which the hard coat layer was formed, but was not observed in a region in which the moth-eye film transferring resin was formed. Therefore, it was found that, in the case where the moth-eye film and the acrylic base were directly bonded to each other without forming the hard coat layer as in Example 1, even if deep holes were formed in part of the die, the phenomenon in which the depressions and projections of the die were clogged with a resin did not readily occur.

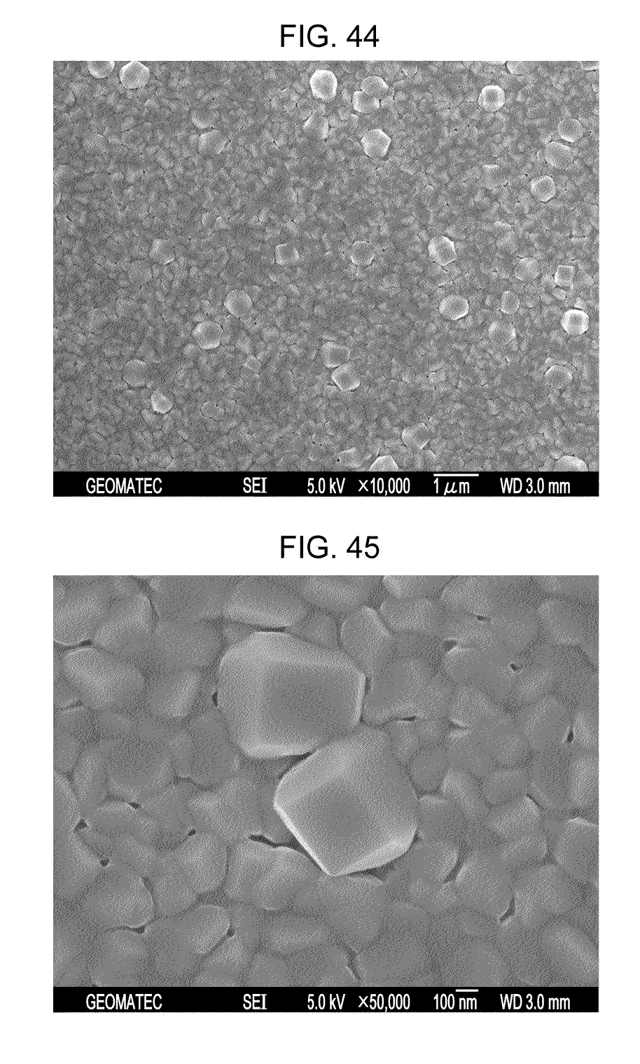

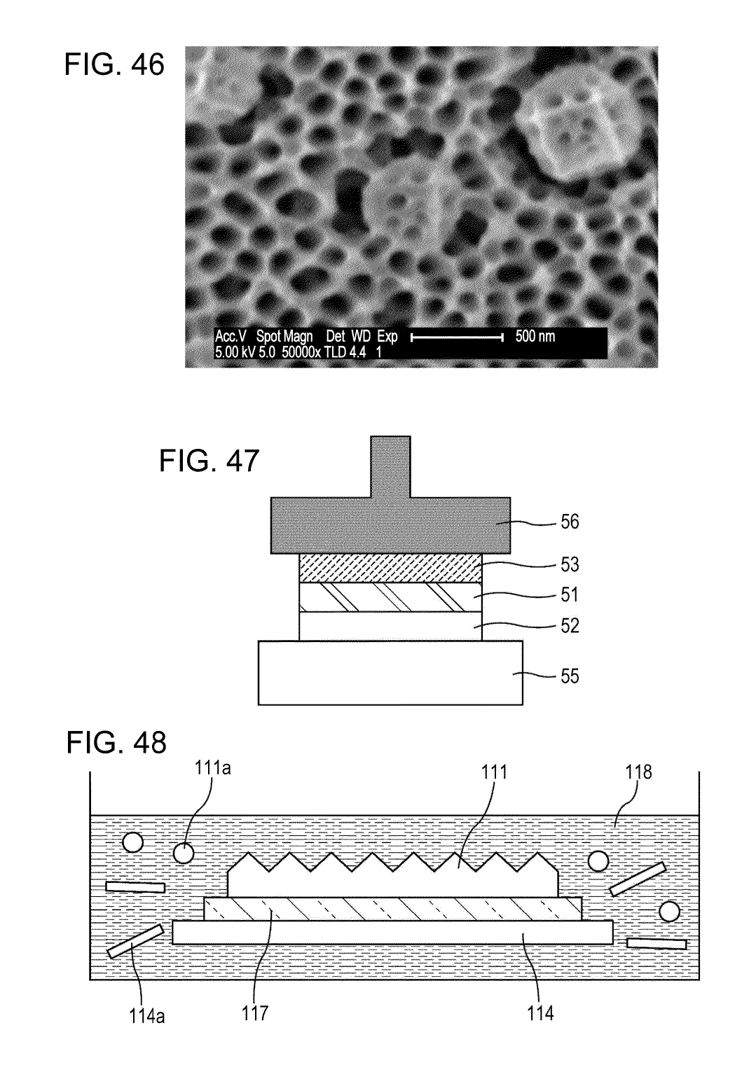

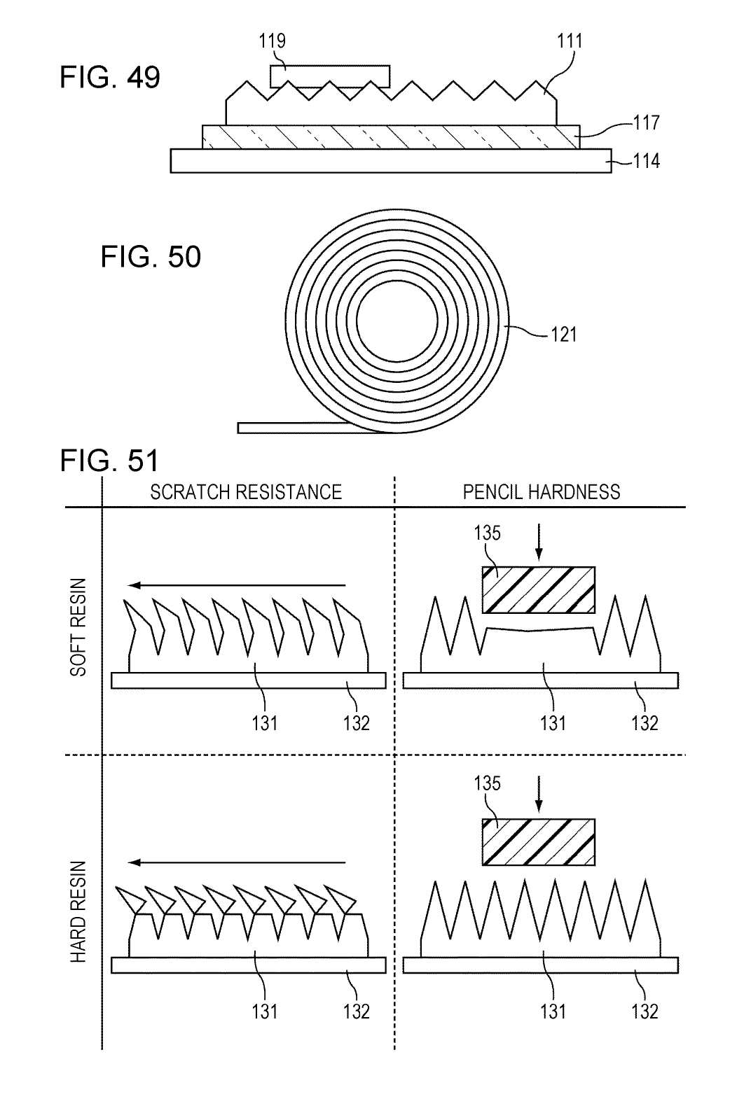

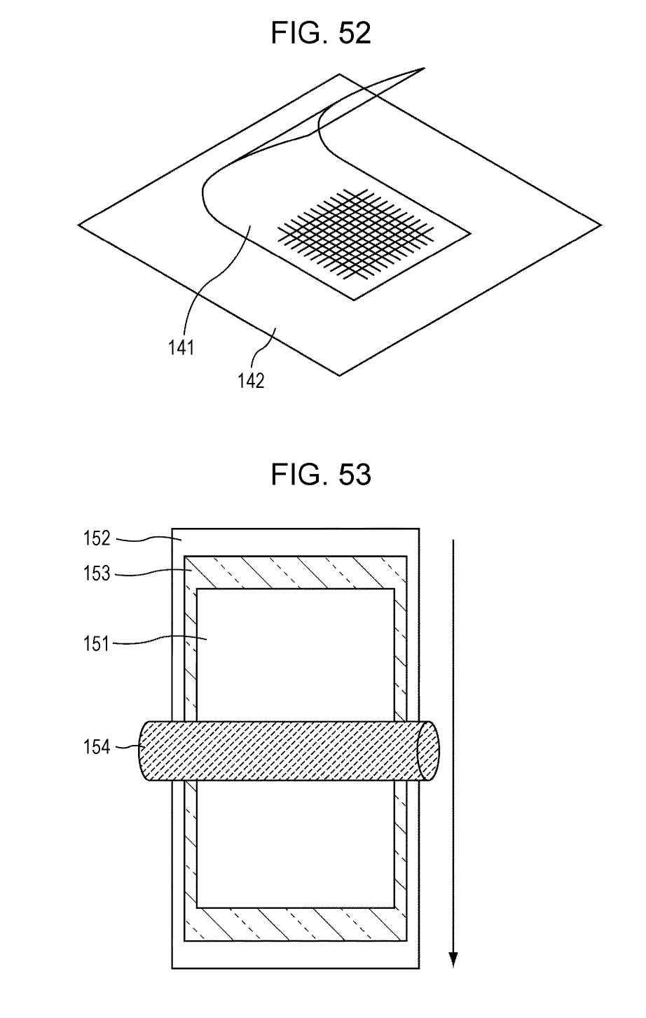

For reference, a phenomenon in which deep holes are formed will be described using photographs in FIGS. 44 to 46 showing the surface of a die in the process of producing the die. FIG. 44 is a low magnification photograph showing the state of abnormally grown particles immediately after the formation of an aluminum film. FIG. 45 is a high magnification photograph showing the state of abnormally grown particles immediately after the formation of an aluminum film. FIG. 46 is a photograph showing the surface of a die after anodization and etching were repeatedly performed. As is clear from FIGS. 44 to 46, holes around abnormally grown particles are particularly deep. The circled region shown in FIG. 42 is believed to be a region in which a portion of an abnormally grown particle was detached during the process of anodization and etching.

For reference, the examination results concerning the adhesiveness between a moth-eye film and an acrylic base will be described. FIG. 47 is a schematic sectional view showing a test for examining the adhesiveness between a moth-eye film and an acrylic base.

Similarly to FIGS. 23 and 34, a laminate including a transferring resin 51 and an acrylic base 52 was placed on a 2 cm square quartz base 55 so that the acrylic base 52 faced the quartz base 55. After a die 53 whose surface had depressions and projections was laid on top of the transferring resin, a load of 200 kg was applied to the laminate while at the same time the laminate was irradiated with ultraviolet light from the quartz base 55 side to form a moth-eye film. After the completion of the curing, a peeling test for checking the adhesive strength between the moth-eye film and the acrylic base was conducted to evaluate the adhesiveness. Two types of acrylic bases (sample a and sample b) commercially available from Technolloy were used as samples. Various thicknesses were set for the samples. Regarding the sample a, a sample a-1 having a thickness of 50 μm, a sample a-2 having a thickness of 75 μm, and a sample a-3 having a thickness of 125 μm were prepared. Regarding the sample b, a sample b-1 having a thickness of 75 μm and a sample b-2 having a thickness of 125 μm were prepared. Note that rubber particles were added to the above two types of acrylic bases to improve the adhesive strength. The rubber particles protruded from one surface of each of the acrylic bases and did not protrude from the other surface.

However, sufficient adhesive strength was not achieved in any of the samples subjected to the above test. A contact angle of water, a contact angle of hexadecane, and the surface free energy were measured for each of the samples. As shown in Table 4 below, there was no particular difference in the values between the samples. Furthermore, there was also no difference in the contact angle of water between the above samples and an example in which a moth-eye film was formed using polyethylene terephthalate (PET) as a base and the adhesiveness was actually achieved.

TABLE 4

| | | Contact angle of water |
|---|---|---|
| Sample a-1 | Front | 83.8° |
| | Back | 75.6° |
| Sample a-2 | Front | 83.6° |
| | Back | 73.2° |
| Sample a-3 | Front | 90.3° |
| | Back | 73.7° |
| Sample b-1 | Front | 82.8° |
| | Back | 75.5° |
| Sample b-2 | Front | 88.7° |
| | Back | 75.7° |
| Adhesion-improving treatment | | 75.0° |
| (lamination with PET) | | |

It was found from the above that whether or not the transferring of the moth-eye film and the acrylic base can be performed, that is, the adhesiveness therebetween had no correlation with a contact angle of water, though there was a correlation between the contact angle of water and the adhesive strength between the polarizing film and the acrylic base.

In other words, it was found that, regarding the adhesive strength between the moth-eye film and the acrylic base and adhesive strength between the polarizing film and the acrylic base, the problem was not overcome through the same idea.

The present application claims priority under the Paris Convention or the domestic law in the country to be entered into national phase on Japanese Patent Application No. 2011-020096, filed on Feb. 1, 2011. The contents of this application are incorporated herein by reference in its entirety.

### REFERENCE SIGNS LIST

1 polarizing plate
2 liquid crystal display panel
3 adhesive
11, 111, 131 moth-eye film
11a protruding portion
12, 32, 42, 52 acrylic base (second base)
13 polarizing film (polarizer)
14 TAC base (first base)
15 adhesive
16 hydrophilic film
21 first roll
22 second roll
23 third roll
24 die coater
25 pinch roll
26 cylindrical member
31, 41, 51, 151 transferring resin
33, 43, 53, 54, 154 die
34, 44 hot plate
35, 45, 55 quartz base
36, 46, 56 pressing machine
37, 47 hand roller
111a transferring resin eluted material
114 TAC film
114a TAC film eluted material
117, 153 hard coat layer
118 saponification liquid
119 crystallized material (needle-shaped foreign matter)
121 TAC film (with moth-eye film)
132, 142, 152 base
135 pencil
141 film to be evaluated

1. A laminate comprising an anti-reflection film including a plurality of protruding portions arranged so that a width between peaks of adjacent protruding portions is less than or equal to a wavelength of visible light and an acrylic base on which the anti-reflection film is placed,
wherein the anti-reflection film and the acrylic base are directly bonded to each other.

2. The laminate according to claim 1, wherein a polarizer is disposed on a surface of the acrylic base, the surface being opposite a surface on which the anti-reflection film is placed.

3. The laminate according to claim 2, wherein an aqueous adhesive layer is formed between the acrylic base and the polarizer, and a hydrophilic film is formed between the acrylic base and the aqueous adhesive layer.

4. A method for producing a laminate including an anti-reflection film including a plurality of protruding portions arranged so that a width between peaks of adjacent protruding portions is less than or equal to a wavelength of visible light and an acrylic base on which the anti-reflection film is placed,
the method comprising a coating step of coating an acrylic base with a resin composition;
after the coating step, a heating step of heating the resin composition at 60° C. or higher for 30 seconds or longer while pressing a die against the resin composition; and
after the heating step, a transferring step of curing the resin composition by irradiating the resin composition with light while keeping the die pressed against the resin composition.

5. The method for producing a laminate according to claim 4, wherein the heating step is a step of heating the resin composition at 100° C. or lower for 3 minutes or shorter.

6. The method for producing a laminate according to claim 4, wherein the resin composition is composed of an undiluted solution for the anti-reflection film.

7. A method for producing a laminate including an anti-reflection film including a plurality of protruding portions arranged so that a width between peaks of adjacent protruding portions is less than or equal to a wavelength of visible light and an acrylic base on which the anti-reflection film is placed,
the method comprising a coating step of coating an acrylic base with a resin material; and
after the coating step, a transferring step of curing a resin composition while pressing a die against the resin composition,
wherein the resin composition is composed of an constituent component of the anti-reflection film and a solvent.

8. The method for producing a laminate according to claim 7, wherein the solvent is a solvent selected from the group consisting of acetone, methyl ethyl ketone, methyl isobutyl ketone, benzene, toluene, xylene, phenol, chloroform, ethylene dichloride, ethylene trichloride, methylene dichloride, ethyl acetate, and glacial acetic acid.

9. The method for producing a laminate according to claim 7, wherein the solvent is a solvent selected from the group consisting of methyl alcohol, ethyl alcohol, butyl alcohol, cyclohexane, cyclohexanone, and butyl acetate.

10. The method for producing a laminate according to claim 7, further comprising, after the coating step, a heating step of heating a resin composition at 60° C. or higher for 30 seconds or longer while pressing a die against the resin composition.

11. The method for producing a laminate according to claim 10, wherein the heating step is a step of heating the resin composition at 100° C. or lower for 3 minutes or shorter.

12. The method for producing a laminate according to claim 4, further comprising a bonding step of bonding a polarizer onto a surface of the acrylic base, the surface being opposite a surface on which the anti-reflection film is placed.

13. The method for producing a laminate according to claim 12, wherein the bonding step includes a hydrophilizing step of forming a hydrophilic film on the acrylic base.

14. The method for producing a laminate according to claim 13, wherein, after the hydrophilizing step, a contact angle at a surface of the acrylic base is 30° or less at 25° C.

15. The method for producing a laminate according to claim 13, further comprising, after the hydrophilizing step, a drying step of volatilizing moisture in the hydrophilic film.
